(19) United States
(12) Patent Application Publication
(10) Pub. No.: US 2023/0013603 A1
(43) Pub. Date: Jan. 19, 2023

(54) MOUNTING ASSEMBLY MOUNTABLE TO A WIRE LATTICE

(71) Applicant: 2840629 ONTARIO INC., Woodbridge (CA)

(72) Inventor: Giuseppe PRIZZI, Kleinburg (CA)

(73) Assignee: 2840629 ONTARIO INC., Woodbridge, ON (CA)

(21) Appl. No.: 17/868,353

(22) Filed: Jul. 19, 2022

Related U.S. Application Data
(60) Provisional application No. 63/223,309, filed on Jul. 19, 2021.
(60) Provisional application No. 63/256,876, filed on Oct. 18, 2021.

(51) Int. Cl. A47F 5/08

(52) U.S. Cl. CPC A47F 5/083

(57) ABSTRACT

Disclosed is a bracket connectible to a wire lattice. The bracket includes an upper connection counterpart defining a hook for hanging the bracket from the lattice. The bracket includes a lower connection counterpart defining a lower rotation-opposing configuration for disposition relative to a lower wire of the lattice. The spacing between the counterparts is adjustable between a rotation resistant-spacing and a rotation-permissive spacing. While the bracket is hanging from the lattice and the spacing is the rotation-resistant spacing, the lower rotation-opposing configuration is disposed relative to the lower wire, such that the lower rotation-opposing configuration opposes rotation of the bracket towards the lattice and also away from the lattice. While the bracket is hanging from the lattice and the spacing is the rotation-permissive spacing, the lower rotation-opposing configuration is disposed relative to the lower wire, such that the bracket is rotatable towards the lattice and also away from the lattice.

### CROSS REFERENCE TO RELATED APPLICATION

This application claims priority to U.S. Provisional Application No. 63/223,309 filed on Jul. 19, 2021, and claims priority to U.S. Provisional Application No. 63/256,876 filed on Oct. 18, 2021, both of which are hereby incorporated herein by reference in their entirety.

### FIELD

The present disclosure relates to a mounting assembly, and in particular, a mounting assembly that is securable to a wire lattice of a wire barrier system or a wire containment system.

### BACKGROUND

To avoid clutter, and to organize objects, such as tools, toys, organizing boxes and bins, equipment, and the like, the objects may be hung from a wire lattice, for example, of a wire barrier system such as a wire panel, wire mesh, wire grid, wire shelving, or a wire fence, such as a chain link fence, or of a wire containment system, such as a wire cage, wire box, wire bin, or wire storage room. A mounting assembly, including a bracket, may be hung from the wire lattice, and the object may be hung from the mounting assembly, such that the object is hung from the wire lattice via the mounting assembly.

Unfortunately, while existing mounting assemblies are hangable from the wire lattice, they are not securable to the wire lattice. Accordingly, existing mounting assemblies may be unintentionally disconnected from the wire lattice, for example, by a user that knocks into the mounting assembly, or while an object is being removed from the mounting assembly. Such unintentional disconnection of the existing mounting assemblies from the wire lattice may require re-hanging of the mounting assembly on the. In addition, since existing mounting assemblies are not securable to the wire lattice, the weight of the object to the hung from the mounting assembly may be limited, to reduce the risk of damage to the wire lattice, the bracket, or the surrounding environment if the object unintentionally falls from the mounting assembly due to unintentional disconnection of the mounting assembly from the wire lattice.

### SUMMARY

In one aspect, there is provided a bracket configured to be connected to a wire lattice, the wire lattice defined by a plurality of wires, the plurality of wires including an upper wire and a lower wire, wherein the lower wire is disposed below the upper wire, the bracket comprising: an upper bracket-defined connection counterpart defining a hook, wherein: the hook is configured for hooking onto the upper wire such that the hook and the upper wire are co-operatively disposed in a hooked configuration, and with effect that the bracket is hanging from the wire lattice; and a lower bracket-defined connection counterpart, disposed below the upper bracket-defined connection counterpart, and defining a lower rotation-opposing configuration for disposition relative to the lower wire; wherein: the spacing between the upper bracket-defined connection counterpart and the lower bracket-defined connection counterpart is adjustable between at least a rotation resistant spacing and a rotation permissive spacing; while: (i) the hook and the upper wire are disposed in the hooked configuration, and (ii) the spacing between the upper bracket-defined connection counterpart and the lower bracket-defined connection counterpart is the rotation-resistant spacing, the lower rotation-opposing configuration is disposed relative to the lower wire, such that the lower rotation-opposing configuration opposes rotation of the bracket, relative to the wire lattice, in a first direction, and also opposes rotation of the bracket, relative to the wire lattice in a second direction, wherein the first direction is opposite to the second direction; and while: (i) the hook and the upper wire are disposed in the hooked configuration, and (ii) the spacing between the upper bracket-defined connection counterpart and the lower bracket-defined connection counterpart is the rotation-permissive spacing, the lower rotation-opposing configuration is disposed relative to the lower wire, such that: (i) there is an absence of opposing of rotation of the bracket, relative to the wire lattice, by the lower rotation-opposing configuration, in the first direction, and (ii) there is an absence of opposing of rotation of the bracket, relative to the wire lattice by the lower rotation-opposing configuration, in the second direction.

In another aspect, there is provided a bracket configured to be connected to a wire lattice, the wire lattice defined by a plurality of wires, the plurality of wires including an upper wire and a lower wire, wherein the lower wire is disposed below the upper wire, the kit comprising: a bracket member, defining an upper bracket-defined connection counterpart defining a hook, wherein: the hook is configured for hooking onto the upper wire such that the hook and the upper wire are co-operatively disposed in a hooked configuration, and with effect that the bracket is hanging from the wire lattice; and a connection counterpart-defining configuration, releasably coupled to the bracket member, and defining a lower bracket-defined connection counterpart, disposed below the upper bracket-defined connection counterpart, the lower bracket-defined connection counterpart defining a lower rotation-opposing configuration for disposition relative to the lower wire; wherein: the spacing between the upper bracket-defined connection counterpart and the lower bracket-defined connection counterpart is adjustable between at least a rotation resistant spacing and a rotation permissive spacing; while: (i) the hook and the upper wire are disposed in the hooked configuration, and (ii) the spacing between the upper bracket-defined connection counterpart and the lower bracket-defined connection counterpart is the rotation-resistant spacing, the lower rotation-opposing configuration is disposed relative to the lower wire, such that the lower rotation-opposing configuration opposes rotation of the bracket, relative to the wire lattice, in a first direction, and also opposes rotation of the bracket, relative to the wire lattice in a second direction, wherein the first direction is opposite to the second direction; and while: (i) the hook and the upper wire are disposed in the hooked configuration, and (ii) the spacing between the upper bracket-defined connection counterpart and the lower bracket-defined connection counterpart is the rotation-permissive spacing, the lower rotation-opposing configuration is disposed relative to the lower wire, such that: (i) there is an absence of opposing of rotation of the bracket, relative to the wire lattice, by the lower rotation-opposing configuration, in the first direction, and (ii) there is an absence of opposing of rotation of the bracket, relative to the wire lattice by the lower rotation-opposing configuration, in the second direction.

In another aspect, there is provided kit for a bracket configured to be connected to a wire lattice, the wire lattice defined by a plurality of wires, the plurality of wires including an upper wire and a lower wire, wherein the lower wire is disposed below the upper wire, the kit comprising: a bracket member, defining an upper bracket-defined connection counterpart defining a hook, wherein: the hook is configured for hooking onto the upper wire such that the hook and the upper wire are co-operatively disposed in a hooked configuration, and with effect that the bracket is hanging from the wire lattice; and a connection counterpart-defining configuration, releasably couplable to the bracket member, and defining a lower bracket-defined connection counterpart, the lower bracket-defined connection counterpart defining a lower rotation-opposing configuration for disposition relative to the lower wire; wherein, while the bracket member and the connection counterpart-defining configuration are releasably coupled, the lower bracket-defined connection counterpart is disposed below the upper bracket-defined connection counterpart, and the bracket is defined, and: the spacing between the upper bracket-defined connection counterpart and the lower bracket-defined connection counterpart is adjustable between at least a rotation resistant spacing and a rotation permissive spacing; while: (i) the hook and the upper wire are disposed in the hooked configuration, and (ii) the spacing between the upper bracket-defined connection counterpart and the lower bracket-defined connection counterpart is the rotation-resistant spacing, the lower rotation-opposing configuration is disposed relative to the lower wire, such that the lower rotation-opposing configuration opposes rotation of the bracket, relative to the wire lattice, in a first direction, and also opposes rotation of the bracket, relative to the wire lattice in a second direction, wherein the first direction is opposite to the second direction; and while: (i) the hook and the upper wire are disposed in the hooked configuration, and (ii) the spacing between the upper bracket-defined connection counterpart and the lower bracket-defined connection counterpart is the rotation-permissive spacing, the lower rotation-opposing configuration is disposed relative to the lower wire, such that: (i) there is an absence of opposing of rotation of the bracket, relative to the wire lattice, by the lower rotation-opposing configuration, in the first direction, and (ii) there is an absence of opposing of rotation of the bracket, relative to the wire lattice by the lower rotation-opposing configuration, in the second direction.

Other aspects will be apparent from the description and drawings provided herein.

### BRIEF DESCRIPTION OF DRAWINGS

In the figures, which illustrate example embodiments,

FIG. 1 is front perspective view of a bracket of a mounting assembly;

FIG. 2 is a rear perspective view of the bracket of FIG. 1;

FIG. 3 is a front view of the bracket of FIG. 1;

FIG. 4 is a rear view of the bracket of FIG. 1;

FIG. 5 is a side view of the bracket of FIG. 1;

FIG. 6 is a front perspective view of a mounting assembly, including a load supporter connected to the bracket of FIG. 1;

FIG. 7 is a rear perspective view of the mounting assembly of FIG. 6;

FIG. 8 is a front view of the mounting assembly of FIG. 6;

FIG. 9 is a rear view of the mounting assembly of FIG. 6;

FIG. 10 is a side view of the mounting assembly of FIG. 6;

FIG. 11 is a front perspective view of the mounting assembly of FIG. 6 and a wire lattice;

FIG. 12 is a side view of the mounting assembly and wire lattice of FIG. 11;

FIG. 13 is a front view of the mounting assembly and the wire lattice of FIG. 11;

FIG. 14 is a front perspective view of the bracket of FIG. 1 hung from a wire lattice;

FIG. 15 is a rear perspective view of the bracket of FIG. 1 hung from a wire lattice;

FIG. 16 is a front view of the bracket of FIG. 1 hung from a wire lattice;

FIG. 17 is a rear view of the bracket of FIG. 1 hung from a wire lattice;

FIG. 18 is a side view of the bracket of FIG. 1 hung from a wire lattice;

FIG. 19 is a front perspective view of the bracket of FIG. 1 secured to a wire lattice;

FIG. 20 is a rear perspective view of the bracket of FIG. 1 secured to a wire lattice;

FIG. 21 is a front view of the bracket of FIG. 1 secured to a wire lattice;

FIG. 22 is a rear view of the bracket of FIG. 1 secured to a wire lattice;

FIG. 23 is a side view of the bracket of FIG. 1 secured to a wire lattice;

FIG. 24 is a front perspective view of the mounting assembly of FIG. 6 secured to a wire lattice;

FIG. 25 is a rear perspective view of the mounting assembly of FIG. 6 secured to a wire lattice;

FIG. 26 is a front view of the mounting assembly of FIG. 6 secured to a wire lattice;

FIG. 27 is a rear view of the mounting assembly of FIG. 6 secured to a wire lattice;

FIG. 28 is a side view of the mounting assembly of FIG. 6 secured to a wire lattice;

FIG. 29 is a front perspective view of the mounting assembly of FIG. 6 hung from a wire lattice;

FIG. 30 is a rear perspective view of the mounting assembly of FIG. 6 hung from a wire lattice;

FIG. 31 is a front view of the mounting assembly of FIG. 6 hung from a wire lattice;

FIG. 32 is a side view of the mounting assembly of FIG. 6 hung from a wire lattice;

FIG. 33 is a front perspective view of the mounting assembly of FIG. 6 secured to a wire lattice;

FIG. 34 is a rear perspective view of the mounting assembly of FIG. 6 secured to a wire lattice;

FIG. 35 is a front view of the mounting assembly of FIG. 6 secured to a wire lattice;

FIG. 36 is a side view of the mounting assembly of FIG. 6 secured to a wire lattice.

FIG. 37 is front perspective view of another embodiment of the mounting assembly;

FIG. 38 is a rear perspective view of the mounting assembly of FIG. 37;

FIG. 39 is a rear perspective view of the mounting assembly of FIG. 37 in a retracted configuration;

FIG. 40 is a front view of the mounting assembly of FIG. 37;

FIG. 41 is a rear view of the mounting assembly of FIG. 37

FIG. 42 is a side view of the mounting assembly of FIG. 37 in a retracted configuration;

FIG. 43 is an enlarged view of the portion of the mounting assembly of FIG. 42, the portion identified by the window A shown in FIG. 42;

FIG. 44 is an enlarged view of the portion of the mounting assembly of FIG. 42, the portion identified by the window B shown in FIG. 42;

FIG. 45 is a top view of the mounting assembly of FIG. 37;

FIG. 46 is a bottom view of the mounting assembly of FIG. 37;

FIG. 47 is a front perspective view of the mounting assembly of FIG. 37 secured to a wire lattice;

FIG. 48 is a rear perspective view of the mounting assembly of FIG. 37 secured to a wire lattice.

FIG. 49 is front perspective view of another embodiment of the mounting assembly;

FIG. 50 is a rear perspective view of the mounting assembly of FIG. 49;

FIG. 51 is a front view of the mounting assembly of FIG. 49;

FIG. 52 is a rear view of the mounting assembly of FIG. 49;

FIG. 53 is a left side view of the mounting assembly of FIG. 49;

FIG. 54 is a right side view of the mounting assembly of FIG. 49;

FIG. 55 is a top view of the mounting assembly of FIG. 49;

FIG. 56 is a bottom view of the mounting assembly of FIG. 49;

FIG. 57 is a front perspective view of the mounting assembly of FIG. 49 secured to a wire lattice;

FIG. 58 is a rear perspective view of the mounting assembly of FIG. 49 secured to a wire lattice.

### DETAILED DESCRIPTION

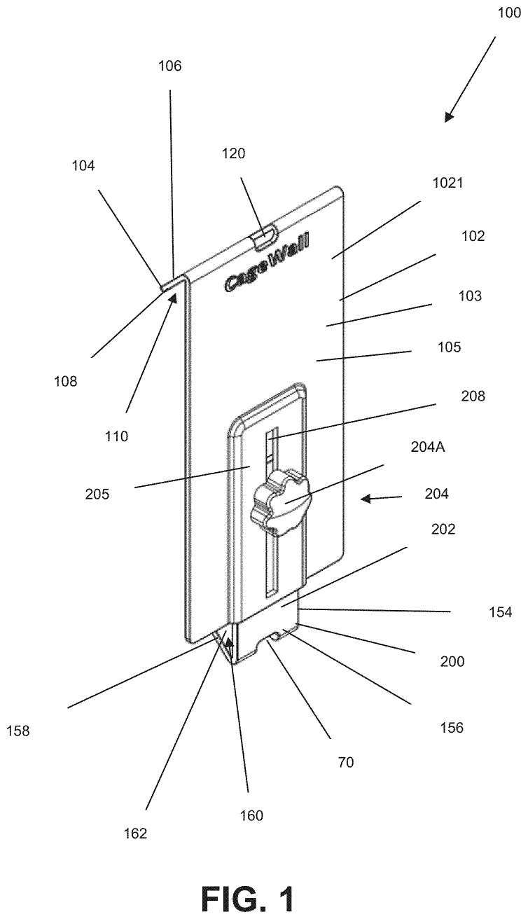

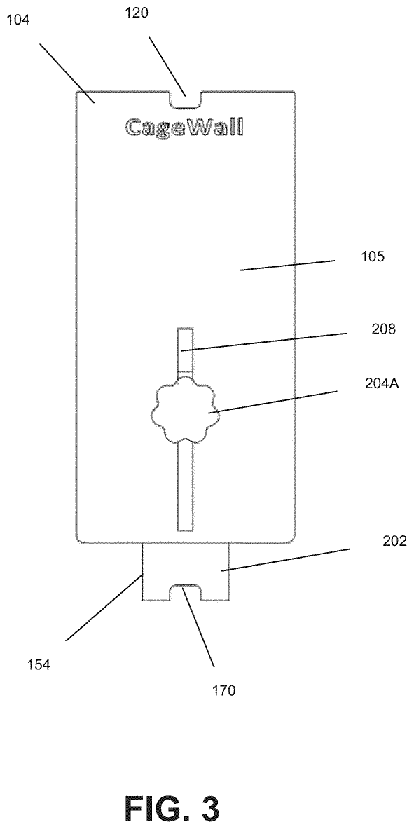

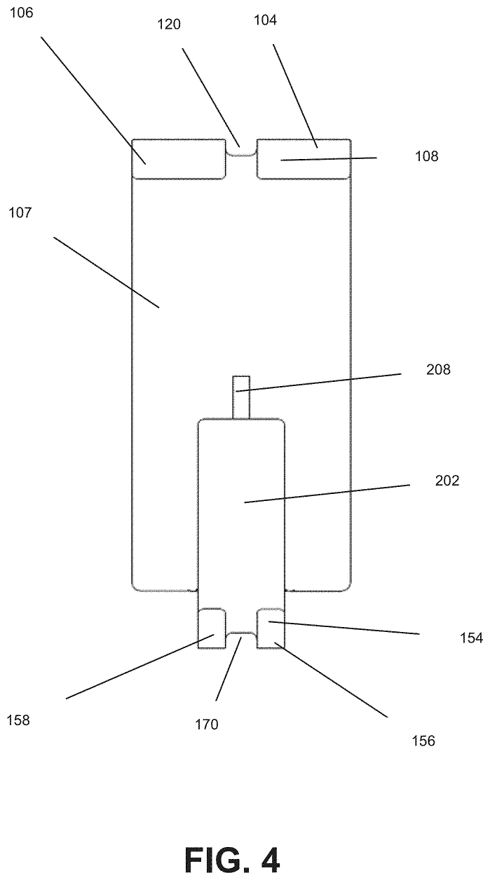

FIG. 1 to FIG. 5 depicts an example embodiment of a mounting assembly 100. In some embodiments, for example, the mounting assembly 100 includes a bracket 102 and a load supporter 300.

The bracket 102 is configured to be connected to a wire lattice 10, for example, of a wire barrier system such as a wire panel, wire mesh, wire grid, wire shelving, or a wire fence, such as a chain link fence, or of a wire containment system, such as a wire cage, wire box, wire bin, or wire storage room. In some embodiments, for example, the wire lattice 10 is defined by a plurality of wires, the plurality of wires including an upper wire 12 and a lower wire 14. In some embodiments, for example, the lower wire 14 is offset from the upper wire 12. In some embodiments, for example, the lower wire 14 is disposed below the upper wire 12.

In some embodiments, for example, the wire lattice 10 includes an intersecting wire 16. In some embodiments, for example, the intersecting wire 16 engages at least one of the upper wire 12 and the lower wire 14. In some embodiments, for example, the intersecting wire 16 engages both of the upper wire 12 and the lower wire 14.

In some embodiments, for example, the upper wire 12 extends along a first axis, the lower wire 14 extends along a second axis, and the intersecting wire 16 extends along a third axis. In some embodiments, for example, the first axis and the second axis are parallel. In some embodiments, for example, the first axis and the second axis are non-parallel. In some embodiments, for example, the first axis and the third axis are non-parallel. In some embodiments, for example, the second axis and the third axis are non-parallel. In some embodiments, for example, the first axis and the third axis are perpendicular. In some embodiments, for example, the second axis and the third axis are perpendicular.

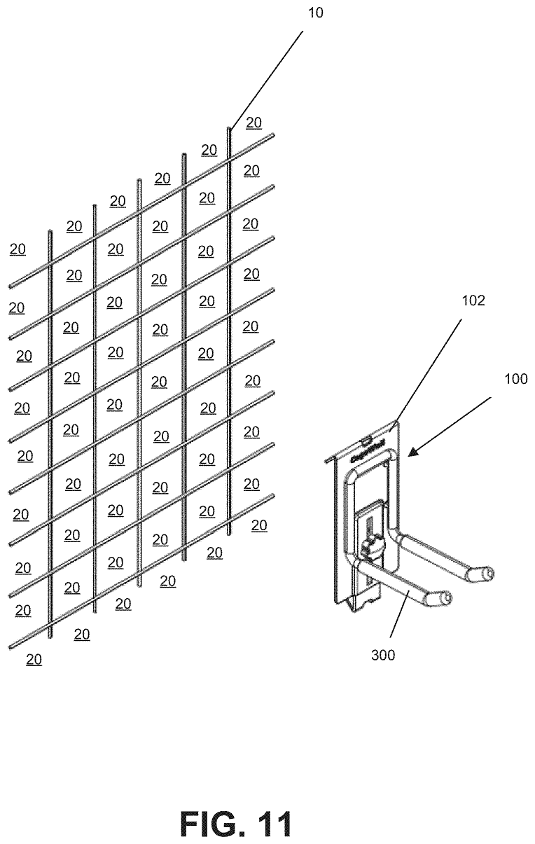

In some embodiments, for example, the wire lattice 10 includes a plurality of openings 20, as depicted in FIG. 11. In some embodiments, for example, the plurality of openings 20 is defined between the plurality of wires of the wire lattice 10.

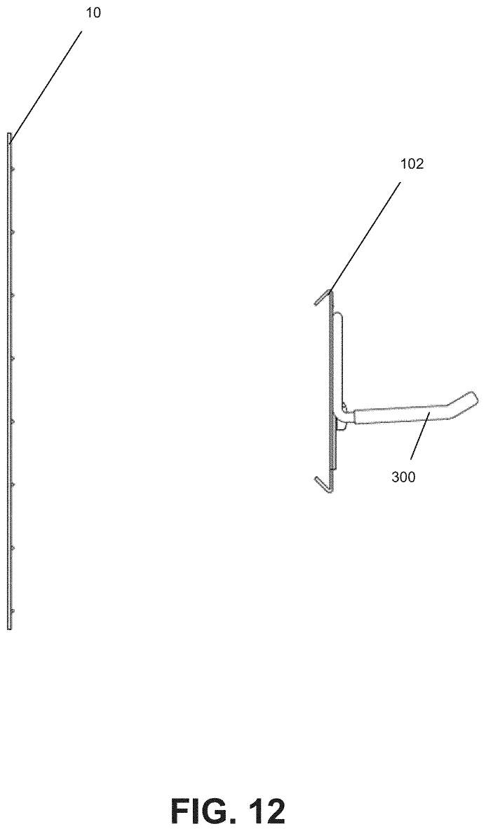

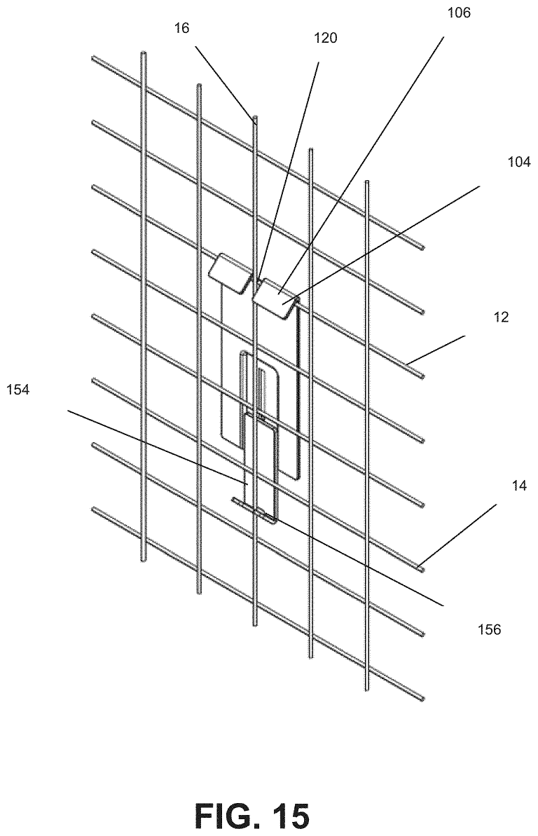

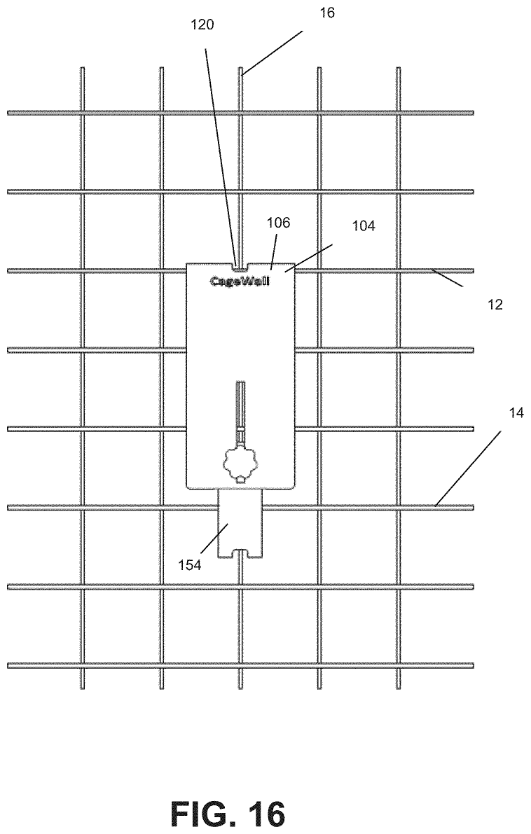

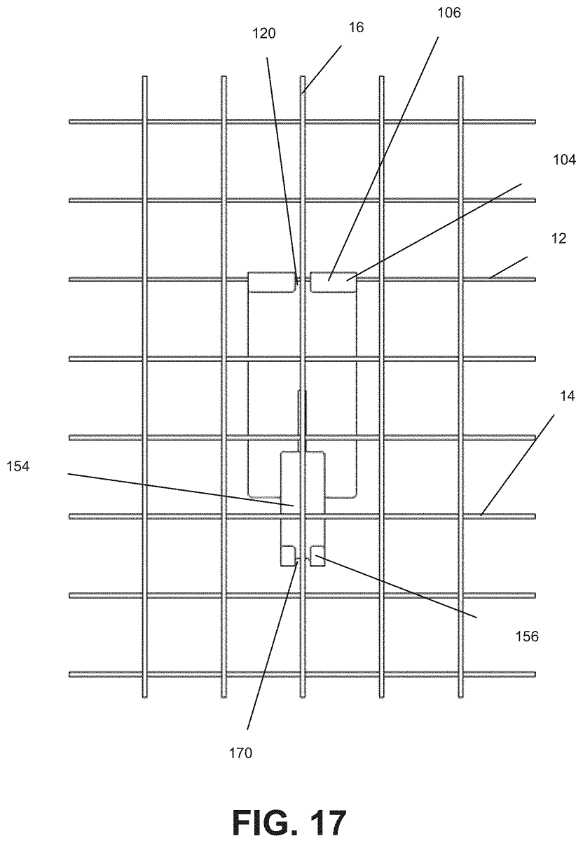

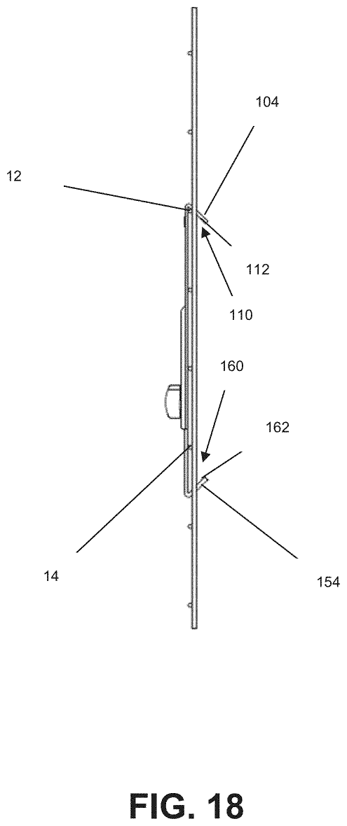

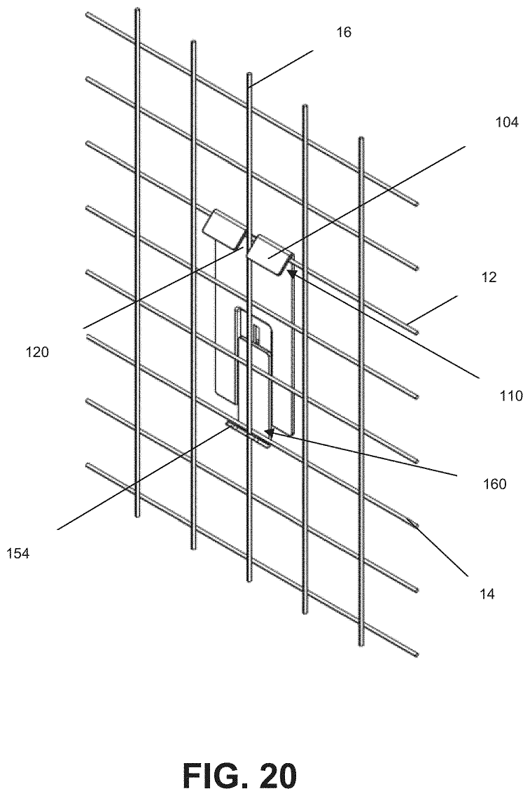

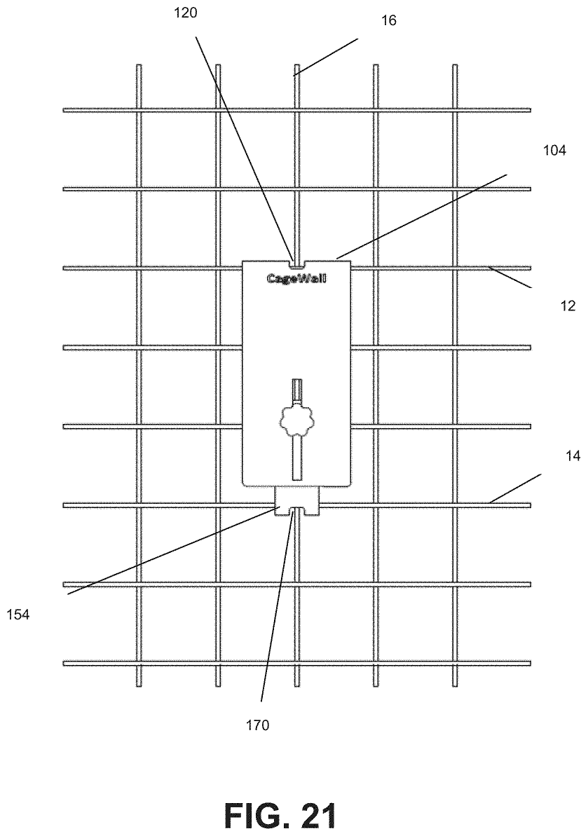

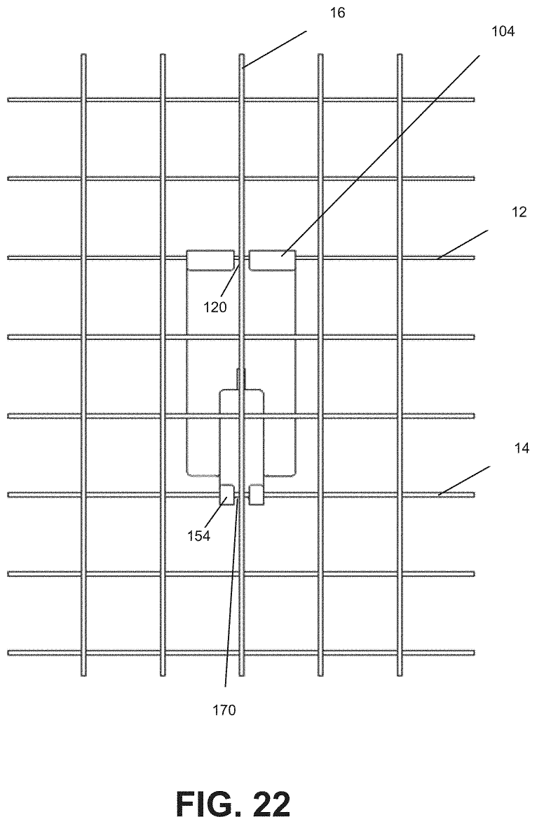

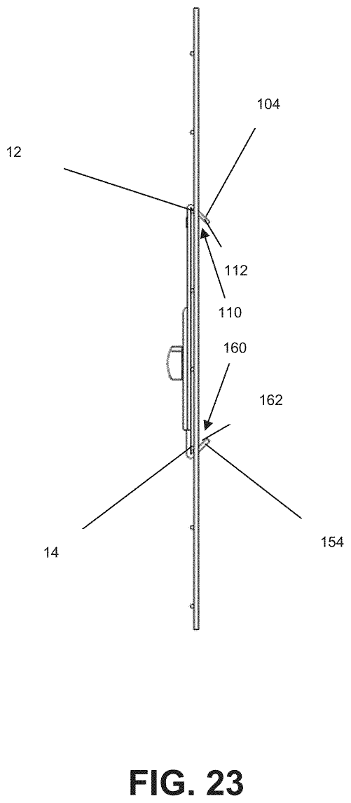

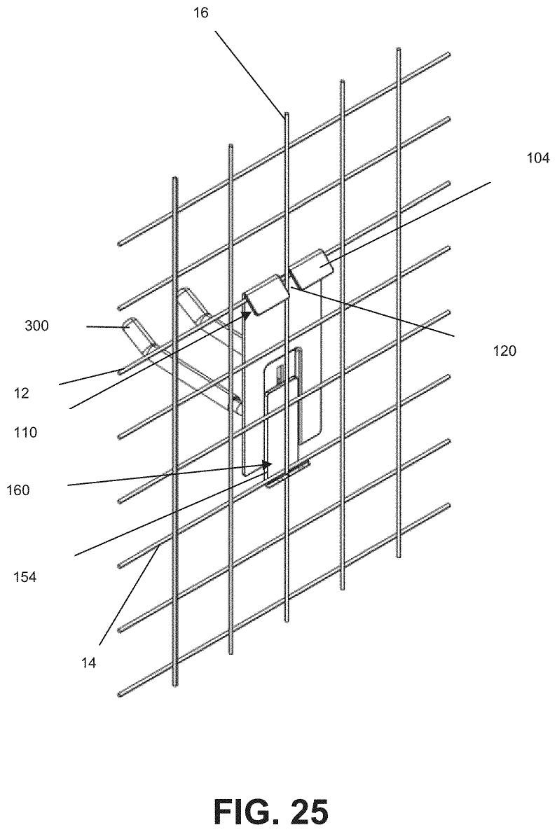

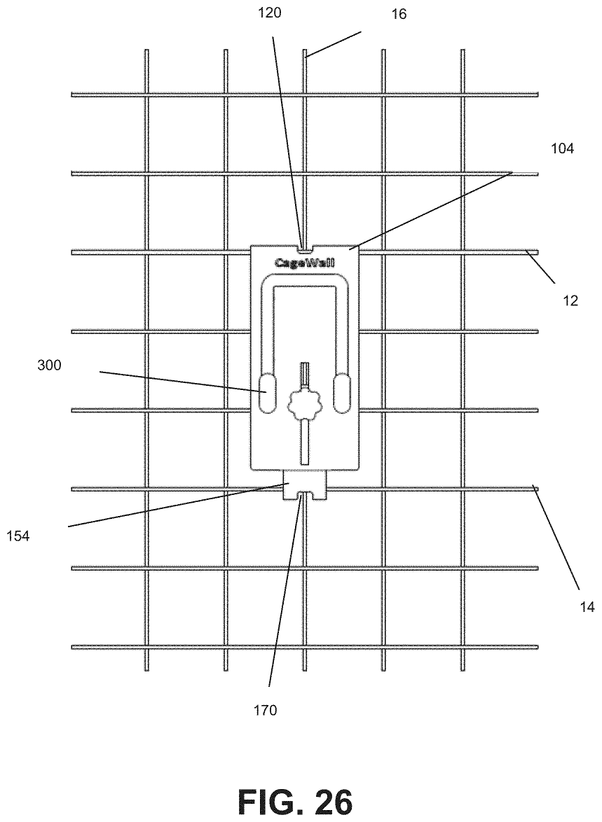

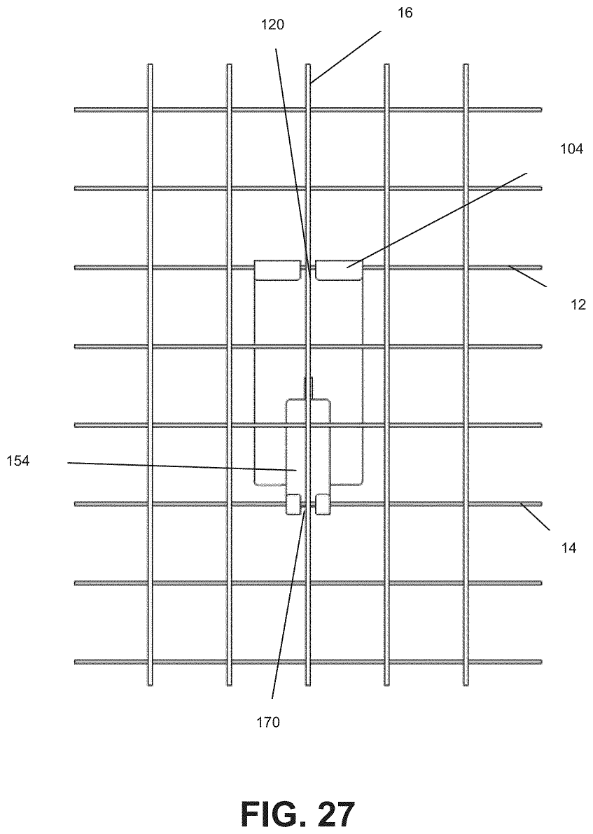

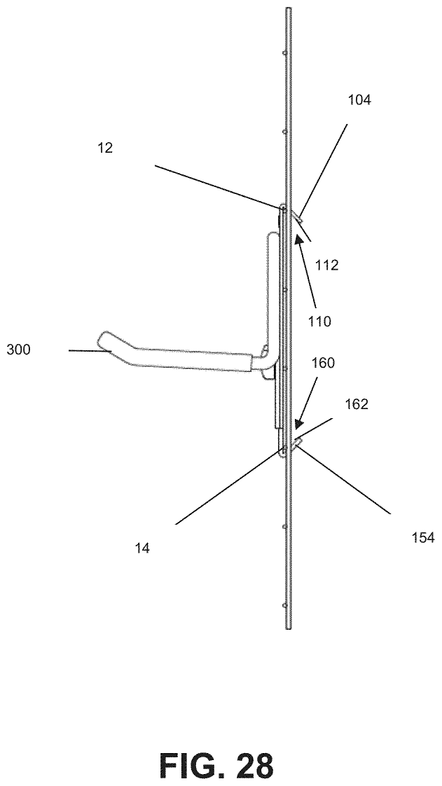

In some embodiments, for example, as depicted in FIG. 11 to FIG. 28, the wire lattice 10 is configurable in an upright configuration, wherein the wires of the wire lattice 10 extend horizontally and vertically, such as the wire lattice 10 of a wire cage or a wire storage room. In some embodiments, for example, while the lattice 10 is configured in the upright configuration, the upper wire 12 and the lower wire 14 extend in a horizontal direction, and the intersecting wire 16 extends in a vertical direction. In some embodiments, for example, the openings 20 of the wire lattice 10 in the upright configuration are square-shaped or rectangular-shaped.

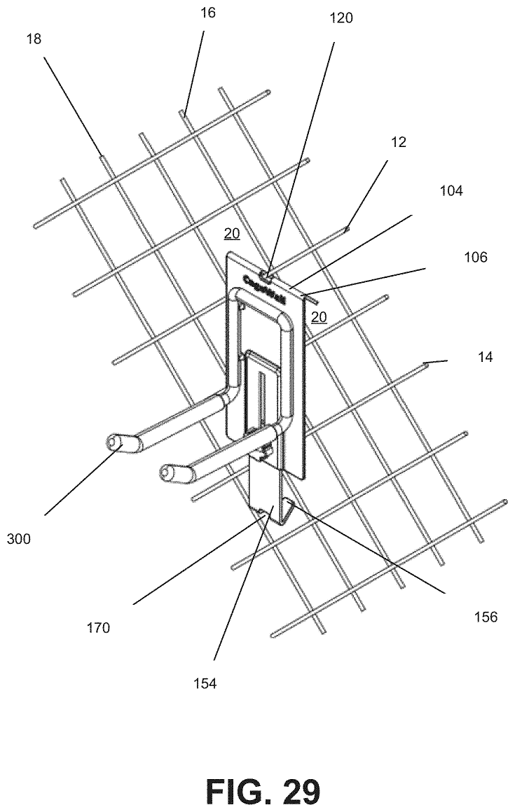

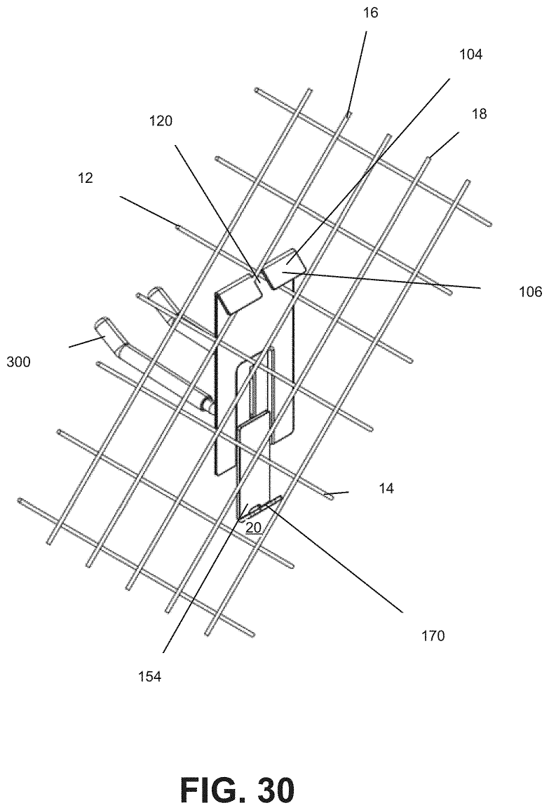

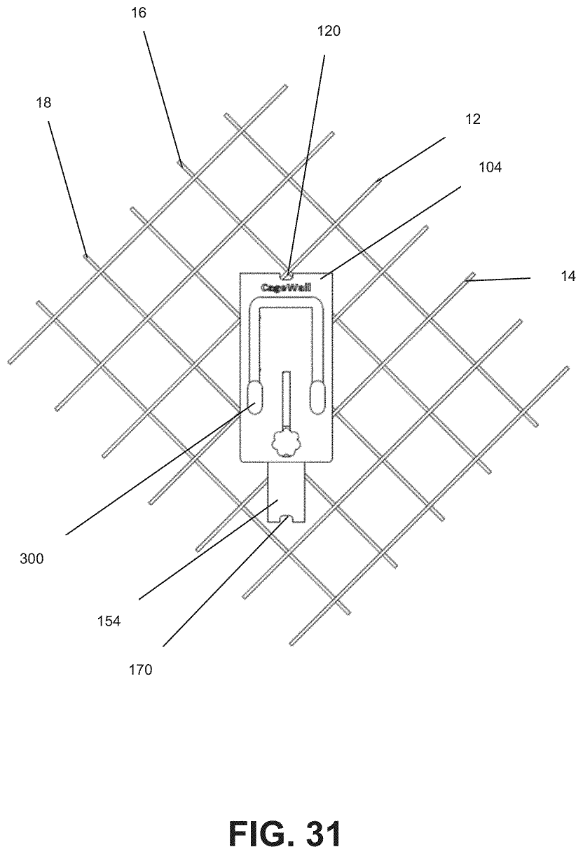

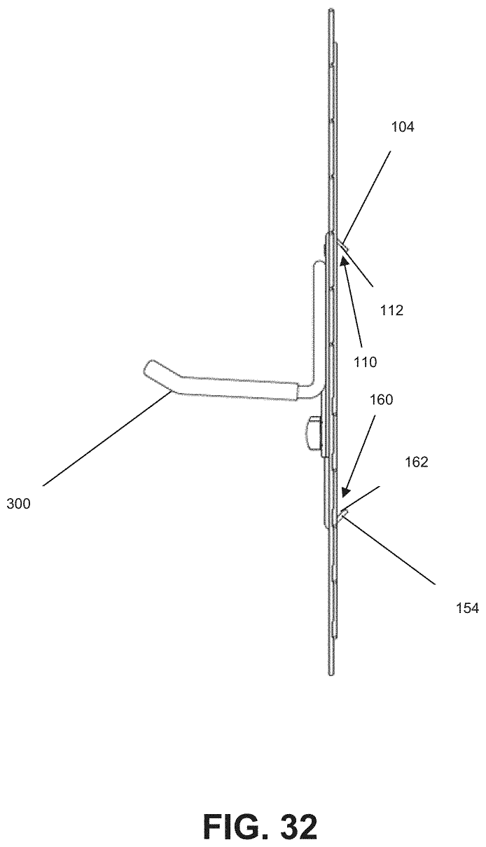

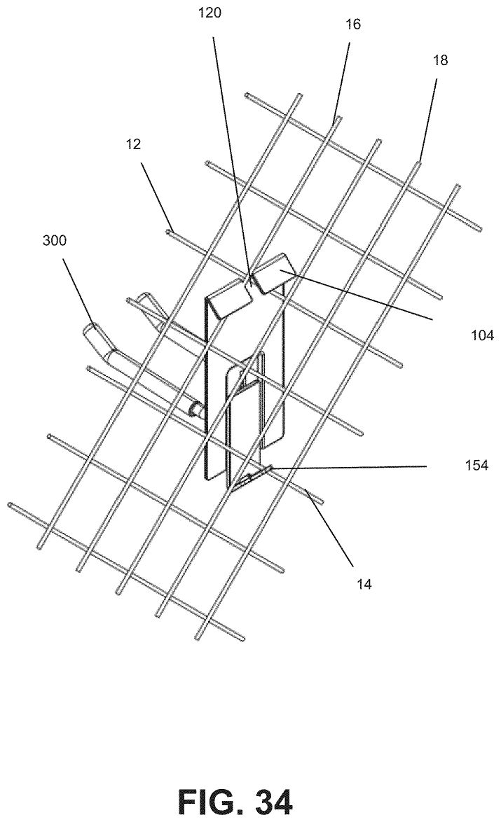

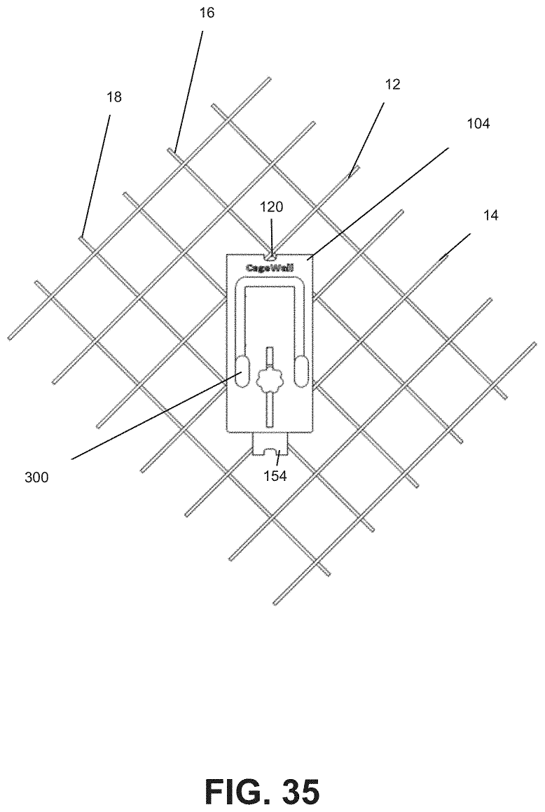

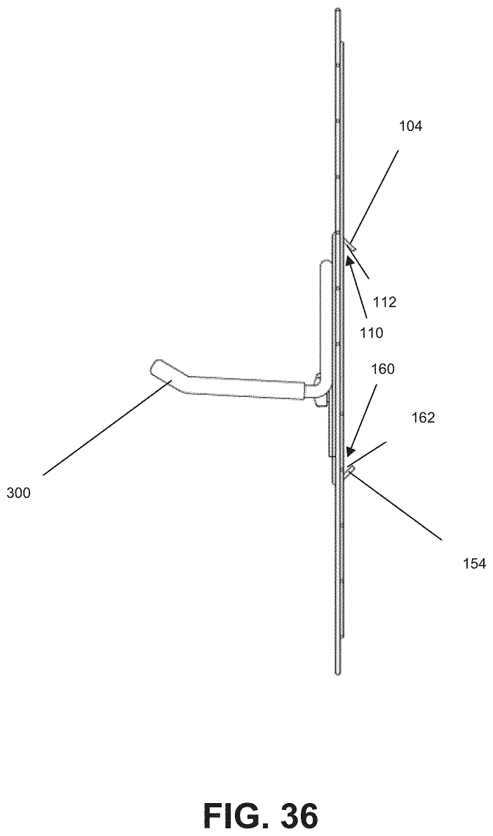

In some embodiments, for example, as depicted in FIG. 29 to FIG. 36, the wire lattice 10 is configurable in an angled configuration, wherein the wires of the wire lattice 10 extend angularly, for example, such as the wire lattice 10 of a chain link fence. In some embodiments, for example, while the lattice 10 is configured in the angled configuration, the upper wire 12 extends along an axis that defines an acute angle with a horizontal axis, wherein the acute angle has a minimum value of at least 1 degree. In some embodiments, for example, while the lattice 10 is configured in the angled configuration, the lower wire 14 extends along an axis that defines an acute angle with a horizontal axis, wherein the acute angle has a minimum value of at least 1 degree. In some embodiments, for example, while the lattice 10 is configured in the angled configuration, the intersecting wire 16 extends along an axis that defines an acute angle with a horizontal axis, wherein the acute angle has a minimum value of at least 1 degree, and wherein: (i) the axis of extension of the intersecting wire 16 and the axis of extension of the upper wire 12 are non-parallel, and (ii) the axis of extension of the intersecting wire 16 and the axis of extension of the lower wire 14 are non-parallel. In some embodiments, for example, the openings 20 of the wire lattice 10 in the upright configuration are diamond-shaped or rhombus-shaped.

In some embodiments, for example, the bracket 102 includes an upper bracket-defined connection counterpart 104 and a lower bracket-defined connection counterpart 154. As depicted in FIG. 1 to FIG. 5, in some embodiments, for example, the upper bracket-defined connection counterpart 104 and the lower bracket-defined connection counterpart 154 are disposed at opposite ends of the bracket 102. In some embodiments, for example, while the bracket 102 is disposed in an operating configuration, the lower bracket-defined connection counterpart 154 is disposed below the upper bracket-defined connection counterpart 104. In some embodiments, for example, the upper bracket-defined connection counterpart 104 is configured to co-operate with the wire lattice 10 such that the bracket 102 is hangable from the wire lattice 10, and the lower bracket-defined connection counterpart 104 is configured to co-operate with the wire lattice 10 such that, while the bracket 102 is hanging from the wire lattice 10, the bracket 102 is securable to the wire lattice 10.

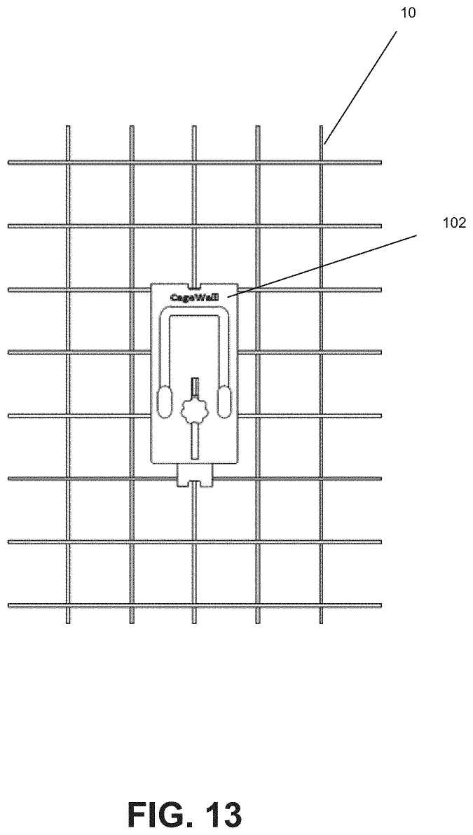

The upper bracket-defined connection counterpart 104 defines a hook 106. In some embodiments, for example, the hook 106 is configured to receive at least a portion of the upper wire 12. In some embodiments, for example, the hook 106 is configured for hooking onto the upper wire 12 such that the hook 106 and the upper wire 12 are co-operatively disposed in a hooked configuration, as depicted, for example, in FIG. 13 to FIG. 36, and with effect that the assembly 100, for example, the bracket 102, is hanging from the wire lattice 10, for example, from the upper wire 12. As depicted in FIG. 1 to FIG. 5, in some embodiments, for example, the hook 106 includes a hook member 108 that extends in a downward direction. In some embodiments, for example, the bracket 102 defines an upper channel 110. The upper channel 110 is configured to receive at least a portion of the upper wire 12 for hanging the assembly 100, for example, the bracket 102, from the upper wire 12.

The lower bracket-defined connection counterpart 154 defines a lower rotation-opposing configuration 156 for disposition relative to the lower wire 14. In some embodiments, for example, the lower rotation-opposing configuration 156 defines a hook. In some embodiments, for example, the lower rotation-opposing configuration 156 and the lower wire 14 are co-operatively configured to secure the connection of the assembly 100 and the wire lattice 10 while the assembly 100, for example, the bracket 102, is hanging from the wire lattice 10. As depicted in FIG. 1 to FIG. 5, in some embodiments, for example, the lower rotation-opposing configuration 156 includes a lower rotation-opposing configuration member 158 that extends in an upward direction. In some embodiments, for example, the bracket 102 defines a lower channel 160. The lower channel 160 is configured to receive at least a portion of the lower wire 14 for securing the connection of the assembly 100 and the wire lattice 10 while the assembly 100 is hanging from the wire lattice 10.

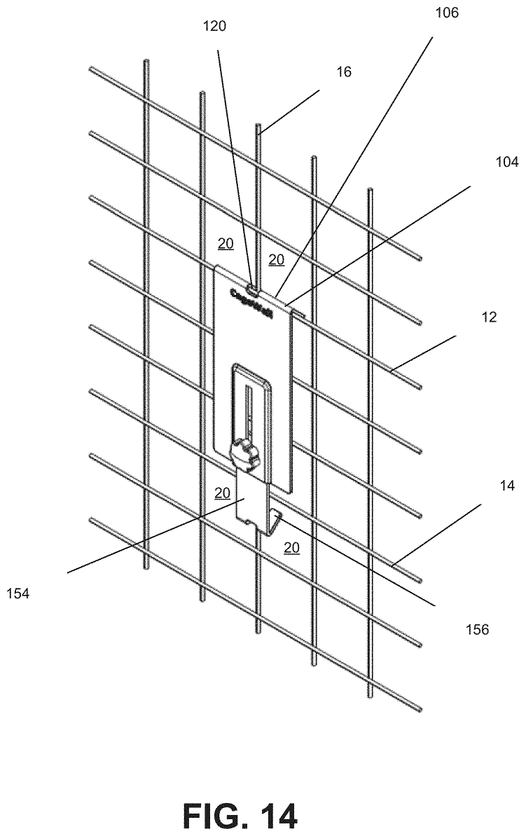

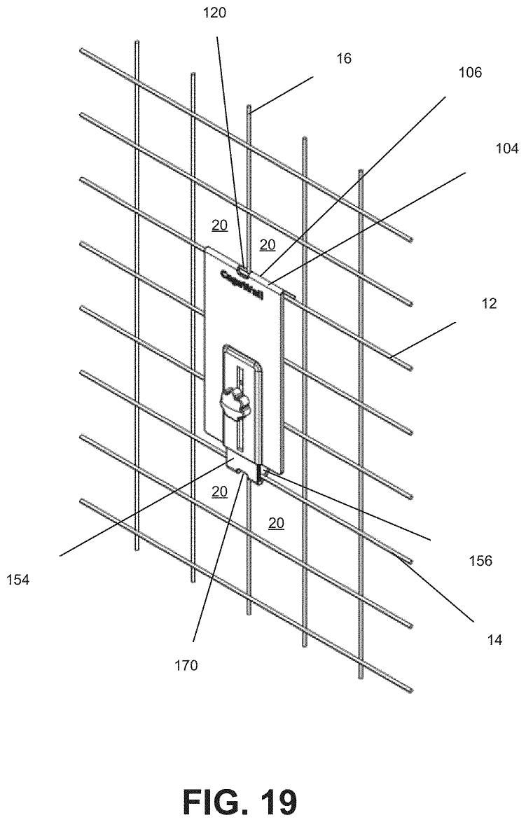

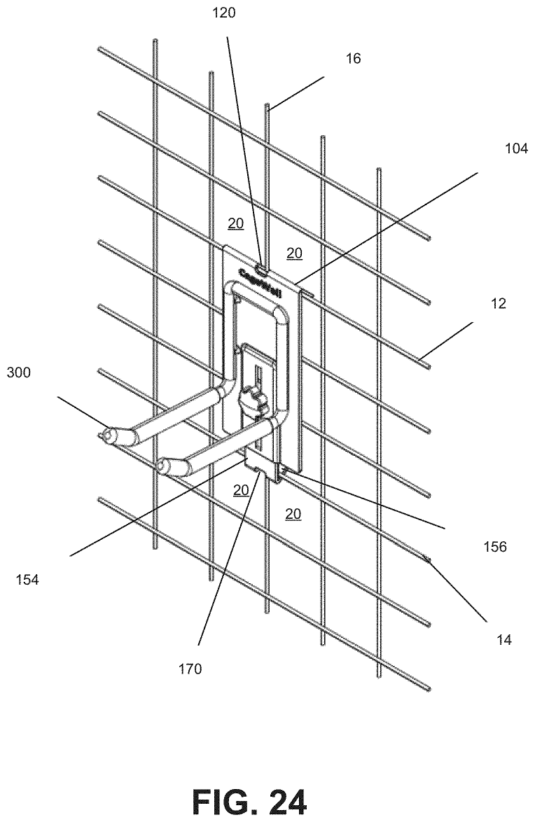

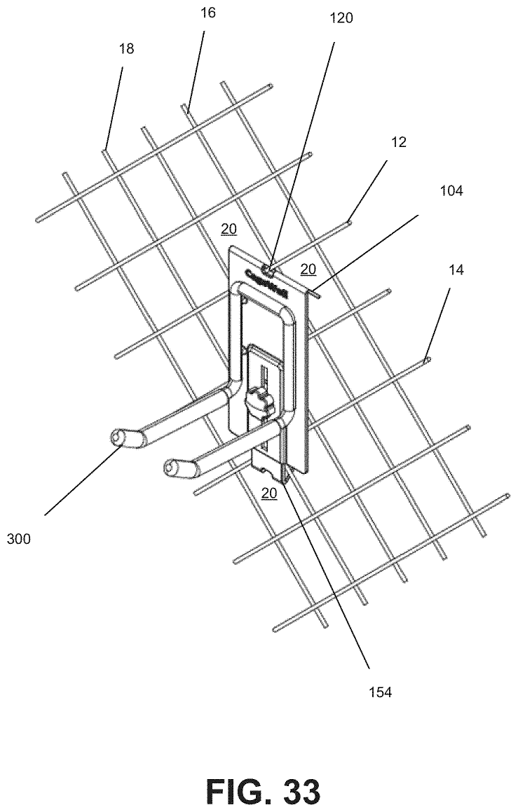

In some embodiments, for example, the spacing between the upper bracket-defined connection counterpart 104 and the lower bracket-defined connection counterpart 154 is adjustable between at least a rotation resistant spacing, as depicted in FIG. 19 to FIG. 23, FIG. 24 to FIG. 28, and FIG. 33 to FIG. 36, and a rotation permissive spacing, as depicted in FIG. 14 to FIG. 18 and FIG. 29 to FIG. 32. As depicted, in some embodiments, for example, the spacing between the upper bracket-defined connection counterpart 104 and the lower bracket-defined connection counterpart 154, while the spacing between the upper bracket-defined connection counterpart 104 and the lower bracket-defined connection counterpart 154 is the rotation permissive spacing, is greater than the spacing between the upper bracket-defined connection counterpart 104 and the lower bracket-defined connection counterpart 154, while the spacing between the upper bracket-defined connection counterpart 104 and the lower bracket-defined connection counterpart 154 is the rotation resistant spacing. In some embodiments, for example, the spacing between the upper bracket-defined connection counterpart 104 and the lower bracket-defined connection counterpart 154, while the spacing between the upper bracket-defined connection counterpart 104 and the lower bracket-defined connection counterpart 154 is the rotation permissive spacing, is less than the spacing between the upper bracket-defined connection counterpart 104 and the lower bracket-defined connection counterpart 154, while the spacing between the upper bracket-defined connection counterpart 104 and the lower bracket-defined connection counterpart 154 is the rotation resistant spacing.

In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-resistant spacing, the lower rotation-opposing configuration 156 is disposed relative to the lower wire 14, such that the lower rotation-opposing configuration 156 opposes rotation of the bracket 102, relative to the wire lattice 10, in a first direction, and also opposes rotation of the bracket 102, relative to the wire lattice 10 in a second direction, wherein the first direction is opposite to the second direction. In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-resistant spacing, the lower rotation-opposing configuration 156 is disposed relative to the lower wire 14, such that the lower rotation-opposing configuration 156 opposes rotation of the bracket 102, relative to the wire lattice 10, in the first direction, and also opposes rotation of the bracket 102, relative to the wire lattice 10, in the second direction, the connection of the assembly 100 and the wire lattice 10 is established.

In some embodiments, for example, the first direction is a direction of rotation towards the wire lattice 10, for example, towards a plane in which the wire lattice 10 is disposed, and the second direction is a direction of rotation away from the wire lattice 10, for example, away from a plane in which the wire lattice 10 is disposed.

In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-resistant spacing, at least a portion of the lower wire 14 is received in the lower channel 160, such that the lower rotation-opposing configuration 156 and the lower wire 14 are co-operatively configured to oppose rotation of the bracket 102, relative to the wire lattice 10, in a first direction, and also opposes rotation of the bracket 102, relative to the wire lattice 10, in a second direction, wherein the first direction is opposite to the second direction.

In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-resistant spacing, the bracket 102 and the wire lattice 10 are co-operatively configured in a rotation-resistant configuration, wherein the lower rotation-opposing configuration 156 is disposed relative to the lower wire 14, such that the lower rotation-opposing configuration 156 opposes rotation of the bracket 102, relative to the wire lattice 10, in a first direction, and also opposes rotation of the bracket 102, relative to the wire lattice 10 in a second direction, wherein the first direction is opposite to the second direction. In some embodiments, for example, while the bracket 102 and the wire lattice 10 are co-operatively configured in the rotation-resistant configuration, at least a portion of at least the lower wire 14 is disposed in the lower channel 160, such that the lower rotation-opposing configuration 156 and the lower wire 14 are co-operatively configured to oppose rotation of the bracket 102, relative to the wire lattice 10, in a first direction, and also opposes rotation of the bracket 102, relative to the wire lattice 10, in a second direction, wherein the first direction is opposite to the second direction.

In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-permissive spacing, the lower rotation-opposing configuration 156 is disposed relative to the lower wire 14, such that: (i) there is an absence of opposing of rotation of the bracket 102, relative to the wire lattice 10, by the lower rotation-opposing configuration 156, in the first direction, and (ii) there is an absence of opposing of rotation of the bracket 102, relative to the wire lattice 10, by the lower rotation-opposing configuration 156, in the second direction.

In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-permissive spacing, the lower wire 14 is disposed outside of the lower channel 160, such that: (i) there is an absence of opposing of rotation of the bracket 102, relative to the wire lattice 10, by the lower rotation-opposing configuration 156, in the first direction, and (ii) there is an absence of opposing of rotation of the bracket 102, relative to the wire lattice 10, by the lower rotation-opposing configuration 156, in the second direction.

In some embodiments, for example, while: (i) the hook 106 and the upper wire 12 are disposed in the hooked configuration, and (ii) the spacing between the upper bracket-defined connection counterpart 104 and the lower bracket-defined connection counterpart 154 is the rotation-permissive spacing, the bracket 102 and the wire lattice 102 are co-operatively configured in the rotation-permissive configuration, wherein the lower rotation-opposing configuration 156 is disposed relative to the lower wire 14, such that: (i) there is an absence of opposing of rotation of the bracket 102, relative to the wire lattice 10, by the lower rotation-opposing configuration 156, in the first direction, and (ii) there is an absence of opposing of rotation of the bracket 102, relative to the wire lattice 10, by the lower rotation-opposing configuration 156, in the second direction. In some embodiments, for example, while the bracket 102 and the wire lattice 102 are co-operatively configured in the rotation-permissive configuration, the lower wire 14 is disposed outside of the lower channel 160, such that: (i) there is an absence of opposing of rotation of the bracket 102, relative to the wire lattice 10, by the lower rotation-opposing configuration 156, in the first direction, and (ii) there is an absence of opposing of rotation of the bracket, relative to the wire lattice 10, by the lower rotation-opposing configuration 156, in the second direction.

In some embodiments, for example, the bracket 102 is configurable in a fixed configuration and an adjustable configuration. In the fixed configuration, there is an absence of adjustability of the spacing between the upper bracket-defined connection counterpart 104 and the lower bracket-defined connection counterpart 154. In the adjustable configuration, spacing between the upper bracket-defined connection counterpart 104 and the lower bracket-defined connection counterpart 154 is adjustable, for example, between at least the rotation resistant spacing and the rotating permissive spacing.

In some embodiments, for example, in the adjustable configuration, spacing between the upper bracket-defined connection counterpart 104 and the lower bracket-defined connection counterpart 154 is adjustable such that the assembly 100 is hangable and securable to a first pair of wires, the first pair of wires including an upper wire and a lower wire, and also to a second pair of wires, the second pair of wires including an upper wire and a lower wire.

In some embodiments, for example, the first pair of wires is spaced apart by a first spacing distance, and the second pair of wires is spaced apart by a second spacing distance. In some embodiments, for example, the first spacing distance and the second spacing distance is the same. In some embodiments, for example, the first spacing distance and the second spacing distance is different. In some embodiments, for example, the first spacing distance is greater than the second spacing distance. In some embodiments, for example, the first spacing distance is less than the second spacing distance.

In some embodiments, for example, the first spacing distance of the first pair of wires is 2 inches. In some embodiments, for example, the second spacing distance of the second pair of wires is 4 inches. In some embodiments, for example, the first spacing distance of the first pair of wires is 6 inches. In some embodiments, for example, the second spacing distance of the second pair of wires is 8 inches. In some embodiments, for example, the first spacing distance of the first pair of wires is 10 inches. In some embodiments, for example, the second spacing distance of the second pair of wires is 12 inches.

In some embodiments, for example, adjusting of the spacing between the upper bracket-defined connection counterpart 104 and the lower bracket-defined connection counterpart 154 from a spacing corresponding to the first spacing, to a spacing corresponding to the second spacing, is effected by displacement of the lower bracket-defined connection counterpart 154 towards the upper bracket-defined connection counterpart 104. In some embodiments, for example, adjusting of the spacing from the spacing corresponding to the second spacing, to the spacing corresponding to the first spacing, is effected by displacement of the lower bracket-defined connection counterpart 154 away from the upper bracket-defined connection counterpart 104.

In some embodiments, for example, adjusting of the spacing between the upper bracket-defined connection counterpart 104 and the lower bracket-defined connection counterpart 154 from the spacing corresponding to the first spacing, to the spacing corresponding to the second spacing, is effected by displacement of the lower bracket-defined connection counterpart 154 away from the upper bracket-defined connection counterpart 104. In some embodiments, for example, adjusting of the spacing from the spacing corresponding second spacing, to the spacing corresponding to the first spacing, is effected by displacement of the lower bracket-defined connection counterpart 154 towards the upper bracket-defined connection counterpart 104.

In some embodiments, for example, the first pair of wires and the second pair of wires are defined on the same wire lattice 10.

In some embodiments, for example, wherein the first pair of wires and the second pair of wires are defined on the same wire lattice 10, the first pair of wires is defined by a first upper wire and a first lower wire, and the second pair of wires is defined by a second upper wire and a second lower wire, wherein the first upper wire and the second upper wire are different wires, and the first lower wire and the second lower wire are different wires.

In some embodiments, for example, wherein the first pair of wires and the second pair of wires are defined on the same wire lattice 10 the first pair of wires is defined by a first upper wire and a first lower wire, and the second pair of wires is defined by the first upper wire and a second lower wire, wherein the first lower wire and the second lower wire are different wires.

In some embodiments, for example, wherein the first pair of wires and the second pair of wires are defined on the same wire lattice 10 the first pair of wires is defined by a first upper wire and a first lower wire, and the second pair of wires is defined by a second upper wire and the first lower wire, wherein the first upper wire and the second upper wire are different wires.

In some embodiments, for example, the first pair of wires is defined on a wire lattice 10, and the second pair of wires is defined on a second wire lattice 10 that is different from the first wire lattice 10.

In some embodiments, for example, as depicted in FIG. 1, the bracket 102 includes a bracket member 1021. In some embodiments, for example, upper bracket-defined connection counterpart 104 is defined by the bracket member 1021. In some embodiments, for example, the bracket member 1021 includes a flange 103, defining a front surface 105 and a rear surface 107 that is disposed on an opposite side of the flange 103 relative to the front surface 105. In some embodiments, for example, the front surface 105 defines a surface configured for being visible while the assembly 100 is hung from the wire lattice 10. In some embodiments, for example, the rear surface 107 defines a lattice-opposing surface configured for opposing the wire lattice 10 while the assembly 100 is hung from the wire lattice 10. In some embodiments, for example, the front surface 105 is the front surface 105 of the bracket 102.

In some embodiments, for example, the flange 103 and the upper bracket-defined connection counterpart 104 are connected. In some embodiments, for example, the bracket member 1021, including the flange 103 and the upper bracket-defined connection counterpart 104, is of unitary one piece construction.

In some embodiments, for example, while the hooked configuration is established, the flange 103 and the wire lattice 10 are disposed in opposing relationship. In some embodiments, for example, while the hooked configuration is established, the flange 103 and the wire lattice 10 are disposed in abutting engagement. In some embodiments, for example, while the hooked configuration is established, the flange 103 is bearing against the wire lattice 10.

As depicted in FIG. 1 to FIG. 5, in some embodiments, for example, the hook member 108 extends in a direction towards the center of the flange 103. In some embodiments, for example, the flange 103 and the hook member 108 are co-operatively configured to define the upper channel 110. In some embodiments, for example, the upper channel 110 is defined between the flange 103 and the hook member 108.

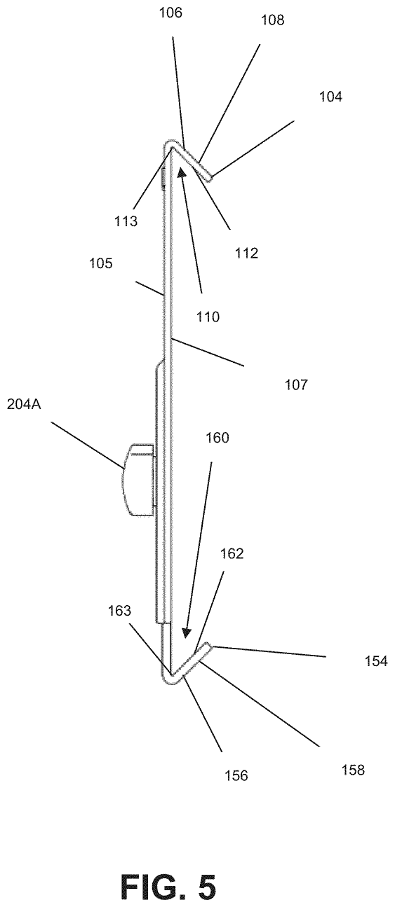

As depicted in FIG. 5, the hook member 108 defines a hook member surface 112 that is disposed in opposing relationship to the rear surface 107. In some embodiments, for example, the acute angle defined between the hook member surface 112 and the rear surface 107 has a minimum value of at least 10 degrees. In some embodiments, for example, the acute angle defined between the hook member surface 112 and the rear surface 107 has a value of 45 degrees. In some embodiments, for example, the size of the upper channel 110 is based on the acute angle defined between the hook member surface 112 and the rear surface 107. In some embodiments, for example, the size of the upper channel 110 increases as the acute angle defined between the hook member surface 112 and the rear surface 107 is increased.

In some embodiments, for example, the upper bracket-defined connection counterpart 104, for example, the hook 106, defines an internal curved surface 113 that extends between the rear surface 107 and the hook member surface 112. In some embodiments, for example, the internal curved surface 113 is configured for disposition in contact engagement with the upper wire 12 while the hook 106 and the upper wire 12 are co-operatively disposed in the hooked configuration. In some embodiments, for example, the radius of curvature of the internal curved surface 113 has a minimum value of at least 1/64″. In some embodiments, for example, the radius of curvature of the internal curved surface 113 has a value of 1/32″. In some embodiments, for example, while the bracket 102 is hanging from the upper wire 12, the upper wire 12 that is disposed in the upper channel 110 is disposed in contact engagement with the internal curved surface 113. In some embodiments, for example, the connection between the bracket 102 and the upper wire 12, for example, the hanging of the bracket 102 from the upper wire 12, is improved while the upper wire 12 is disposed in contact engagement with the internal curved surface 113, which reduces the risk of unintentional disconnection of the assembly 100 from the wire lattice 10.

In some embodiments, for example, while the bracket 102 is hanging from the upper wire 12, the radius of the upper wire 12 is such that contact engagement of the upper wire 12 with the internal curved surface 113 is absent. In some embodiments, for example, while the bracket 102 is hanging from the upper wire 12, the radius of the upper wire 12 is greater than the radius of curvature of the internal curved surface 113 such that contact engagement of the upper wire 12 with the internal curved surface 113 is absent. In such embodiments, for example, the upper wire 12 is disposed in contact engagement with the hook member surface 112 and the rear surface 107 while the bracket 102 is hanging from the upper wire 12.

As depicted in FIG. 1 to FIG. 5, in some embodiments, for example, the lower rotation-opposing configuration member 158 extends in a direction towards the center of the flange 103. In some embodiments, for example, the flange 103 and the lower rotation-opposing configuration member 158 are co-operatively configured to define the lower channel 160. In some embodiments, for example, the lower channel 160 is defined between the flange 103 and the lower rotation-opposing configuration member 158.

As depicted in FIG. 5, the lower rotation-opposing configuration member 158 defines a lower rotation-opposing configuration member surface 162 that is disposed in opposing relationship to the rear surface 107. In some embodiments, for example, the acute angle defined between the lower rotation-opposing configuration member surface 162 and the rear surface 107 has a minimum value of at least 10 degrees. In some embodiments, for example, the acute angle defined between the lower rotation-opposing configuration member surface 162 and the rear surface 107 has a value of 45 degrees. In some embodiments, for example, the size of the lower channel 160 is based on the acute angle defined between the lower rotation-opposing configuration member surface 162 and the rear surface 107. In some embodiments, for example, the size of the lower channel 160 increases as the acute angle defined between the lower rotation-opposing configuration member surface 162 and the rear surface 107 is increased.

In some embodiments, for example, the lower bracket-defined connection counterpart 154, for example, the lower rotation-opposing configuration 156, defines an internal curved surface 163 that extends between the rear surface 107 and the lower rotation-opposing configuration member surface 162. In some embodiments, for example, the internal curved surface 163 is configured for disposition in contact engagement with the lower wire 14 while: (i) the hook 106 and the upper wire 12 are co-operatively disposed in a hooked configuration, and (ii) the spacing between the upper bracket-defined connection counterpart 104 and the lower bracket-defined connection counterpart 154 is a rotation-resistant spacing. In some embodiments, for example, the radius of curvature of the internal curved surface 163 has a minimum value of at least 1/64″. In some embodiments, for example, the radius of curvature of the internal curved surface 163 has a value of 1/32″. In some embodiments, for example, while the assembly 100 is hanging from the wire lattice 10, and while the connection of the assembly 100 to the wire lattice 10 is secured by the co-operative configuration of the lower rotation-opposing configuration 156 and the lower wire 14, the lower wire 14 that is disposed in the lower channel 160 is disposed in contact engagement with the internal curved surface 163. In some embodiments, for example, the securing of the connection between the assembly 100 and the wire lattice 10 is improved while the lower wire 14 is disposed in contact engagement with the internal curved surface 163, which reduces the risk of unintentional disconnection of the lower rotation-opposing configuration 156 from the lower wire 14 or unintentional displacement of the assembly 100 relative to the wire lattice.

In some embodiments, for example, while the connection of the assembly 100 and the wire lattice 10 is secured via co-operative configuration of the lower rotation-opposing configuration 156 and the lower wire 14, the radius of the lower wire 14 is such that contact engagement of the lower wire 14 with the internal curved surface 163 is absent. In some embodiments, for example, while the connection of the assembly 100 and the wire lattice 10 is secured via co-operative configuration of the lower rotation-opposing configuration 156 and the lower wire 14, the radius of the lower wire 14 is greater than the radius of curvature of the internal curved surface 163 such that contact engagement of the lower wire 14 with the internal curved surface 163 is absent. In such embodiments, for example, the lower wire 14 is disposed in contact engagement with the lower rotation-opposing configuration member surface 162 and the rear surface 107 while the connection of the assembly 100 and the wire lattice 10 is secured via co-operative configuration of the lower rotation-opposing configuration 156 and the lower wire 14.

In some embodiments, for example, the bracket 102 comprises a connection counterpart-defining configuration 200. In some embodiments, for example, the bracket member 1021 is releasably couplable to the connection counterpart-defining configuration 200. In some embodiments, for example, the connection counterpart-defining configuration 200 is releasably couplable to the flange 103 of the bracket member 1021. In some embodiments, for example, the releasable coupling of the bracket member 1021 and the connection counterpart-defining configuration 200 is effected by the releasable coupling of the flange 103 and the connection counterpart-defining configuration 200. In some embodiments, for example, while the bracket member 1021 is releasably coupled to the connection counterpart-defining configuration 200, the bracket 102 is defined. In some embodiments, for example, the releasable coupling of the bracket member 1021 and the connection counterpart-defining configuration 200 is such that the connection counterpart-defining configuration 200 slidably coupled to the bracket member 1021, for example, to the flange 103.

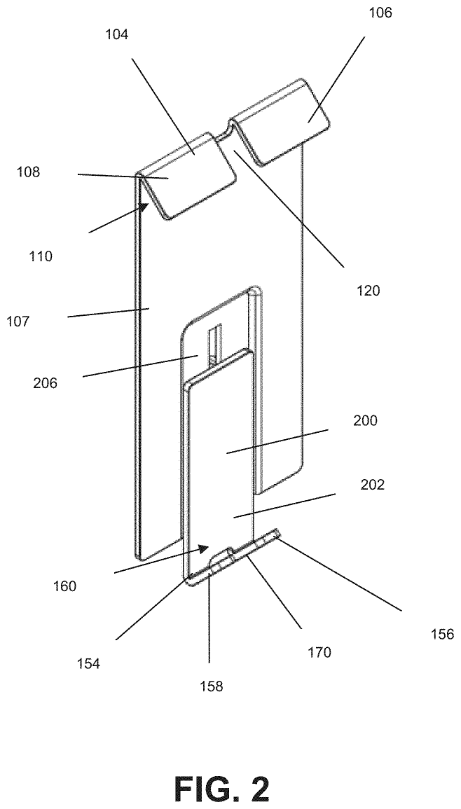

As depicted in FIG. 1 and FIG. 2, the lower bracket-defined connection counterpart 154 is defined by the connection counterpart-defining configuration 200. As depicted, in some embodiments, for example, the connection counterpart-defining configuration 200 includes an intermediate member 202. In some embodiments, for example, the lower bracket-defined connection counterpart 154 is connected to the intermediate member 202. In some embodiments, for example, the connection counterpart-defining configuration 200, which includes the lower bracket-defined connection counterpart 154 and the intermediate member 202, is of unitary one piece construction.

The bracket member 1021 is releasably couplable to the connection counterpart-defining configuration 200, such that, while the bracket member 1021 and the connection counterpart-defining configuration 200 are releasably coupled, the relative displacement is effectible between the bracket member 1021 and the connection counterpart-defining configuration 200. In some embodiments, for example, adjusting of the spacing between the upper bracket-defined connection counterpart 104 and the lower bracket-defined connection counterpart 154 is effectible by relative displacement between the bracket member 1021 and the connection counterpart-defining configuration 200. In some embodiments, for example, the relative displacement effectible between the bracket member 1021 and the connection counterpart-defining configuration 200includes sliding displacement.

In some embodiments, for example, the displacement of the connection counterpart-defining configuration 200, relative to the bracket member 1021 is along a displacement axis that is parallel to the longitudinal axis of the bracket member 1021. In some embodiments, for example, the displacement axis is parallel to a vertical axis.

In some embodiments, for example, the assembly 100 includes a locking mechanism 204. In some embodiments, for example, the locking mechanism 204 includes a rotatable head 204A, and a threaded rod or stud that is releasably couplable to the rotatable head 204A via the threading at a first end of the threaded stud, and that is also connected to the connection counterpart-defining configuration 200, for example, the intermediate member 202, via welding, at the second end of the threaded stud. As depicted in FIG. 1 and FIG. 2, the intermediate member 202 is disposed on a first side of the flange 103 (e.g. rear side of the flange 103), and the rotatable head 204A is disposed on a second side of the flange 103 that is opposite the first side (e.g. front side of the flange 103).

In some embodiments, for example, the locking mechanism 204 is configured to effect frictional engagement between the flange 103 and the intermediate member 202, and further configured to defeat the frictional engagement between the flange 103, and the intermediate member 202.

The bracket member 1021, the connection counterpart-defining configuration 200, and the locking mechanism 204 are co-operatively configured to transition between a displacement-effective configuration and a displacement ineffective configuration. In the displacement effective configuration, the bracket member 1021, the connection counterpart-defining configuration 200, and the locking mechanism 204 are co-operatively configured such that there is an absence of frictional engagement of the flange 103 and the intermediate member 202 by the locking mechanism 204, such that the bracket 102 is disposed in the adjustable configuration, wherein the connection counterpart-defining configuration 200 is displaceable relative to the bracket member 1021. In the displacement ineffective configuration, the bracket member 1021, the connection counterpart-defining configuration 200, and the locking mechanism 204 are co-operatively configured such that frictional engagement of the flange 103 and the intermediate member 202 is effected by the locking mechanism 204, such that the bracket 102 is disposed in the fixed configuration, wherein relative displacement between the connection counterpart-defining configuration 200 and the bracket member 1021 is resisted.

In some embodiments, for example, the bracket member 1021, the connection counterpart-defining configuration 200, and the locking mechanism 204 are transitionable from the displacement effective configuration to the displacement-ineffective configuration in response to actuation of the locking mechanism 204, for example, by rotation of the head 204A in a first direction, for example, a clockwise direction. In some embodiments, for example, in response to actuation of the locking mechanism 204 in the first direction, a force is applied by the locking mechanism 204 to the connection counterpart-defining configuration 200 to displace the connection counterpart-defining configuration 200 towards the flange 103, such that at the intermediate member 202 becomes disposed in frictional engagement with the flange 103, with effect that the bracket 102 becomes disposed in the fixed configuration.

In some embodiments, for example, the bracket member 1021, the connection counterpart-defining configuration 200, and the locking mechanism 204 are transitionable from the displacement ineffective configuration to the displacement effective configuration in response to actuation of the locking mechanism 204, for example, by rotation of the head 204A in a second direction that is opposite the first direction, for example, a counter clockwise direction. In some embodiments, for example, in response to actuation of the locking mechanism 204 in the second direction, a force is applied by the locking mechanism 204 to the connection counterpart-defining configuration 200 to displace the connection counterpart-defining configuration 200 away from the flange 103, such that frictional engagement between the flange 103 and the intermediate member 202 is defeated, with effect that the bracket 102 becomes disposed in the adjustable configuration.

In some embodiments, for example, the bracket 102 includes a slot 208. As depicted, in some embodiments, for example, the slot 208 is a linear slot. As depicted, the slot 208 is defined by the flange 103. The slot 208 extends from a bottom end of the flange 103. As depicted in FIG. 1 to FIG. 3, the slot 208 extends from the bottom end of the flange 103 to the middle of the flange 103. In some embodiments, for example, the length of the slot 208 is generally half the length of the flange 103. In some embodiments, for example, the length of the slot 208 is greater than or less than half the length of the flange 103. The slot 208 is configured to receive at least a portion of the threaded stud of the locking mechanism 204, such that the threaded stud extends through the slot 208, such that, while the rotatable head 204A is releasably coupled to the threaded stud via the threading, the bracket member 1021 and the connection counterpart-defining configuration 200 are releasably coupled, and the intermediate member 202 is disposed on the first side of the flange 103 (e.g. rear side of the flange 103), and the rotatable head 204A is disposed on the second side of the flange 103 that is opposite the first side (e.g. front side of the flange 103). In some embodiments, for example, the slot 208 limits displacement of the threaded stud of the locking mechanism 204, and therefore, limits the displacement of the connection counterpart-defining configuration 200, relative to the bracket member 1021. In some embodiments, for example, the slot 208 defines an upper terminal end that limits further upward displacement of the threaded stud of the locking mechanism 204 and therefore, limits further upward displacement of the connection counterpart-defining configuration 200, relative to the bracket member 1021. In some embodiments, for example, the slot 208 defines a lower terminal end that limits further downward displacement of the threaded stud of the locking mechanism 204 and therefore, limits further downward displacement of the connection counterpart-defining configuration 200, relative to the bracket member 1021.

In some embodiments, for example, as depicted in FIG. 1, the flange 103 includes a raised portion 205 that defines a recess 206 for receiving at least a portion of the connection counterpart-defining configuration 200, in particular, for receiving at least a portion of the intermediate member 202. While the bracket member 1021 and the connection counterpart-defining configuration 200 are releasably coupled, at least a portion of the intermediate member 202 is received in the recess 206.

In some embodiments, for example, the flange 103 includes the recess 206 for receiving at least a portion of the intermediate member 202, while the bracket member 1021 and the connection counterpart-defining configuration 200 are releasably coupled, such that, while the bracket member 1021 and the connection counterpart-defining configuration 200 are releasably coupled, the intermediate member 202 is not disposed rearwardly of the rear surface 107 of the flange 103. In some embodiments, for example, it is desirable for the intermediate member 202 to not be disposed rearwardly of the rear surface 107 of the flange 103, while the bracket member 1021 and the connection counterpart-defining configuration 200 are releasably coupled, as disposition of the intermediate member 202 rearwardly of the rear surface 107, while the bracket member 1021 and the connection counterpart-defining configuration 200 are releasably coupled, interferes with the securing of the mounting assembly 100 to the wire lattice 10.

In some embodiments, for example, the recess 206 and the connection counterpart-defining configuration 200 are co-operatively configured such that the connection counterpart-defining configuration 200 is slidable, relative to the bracket member 1021 while the at least a portion of the connection counterpart-defining configuration 200, for example, the intermediate member 202, is received in the recess 206.

As depicted, in some embodiments, for example, the slot 208 is defined by the raised portion 205.

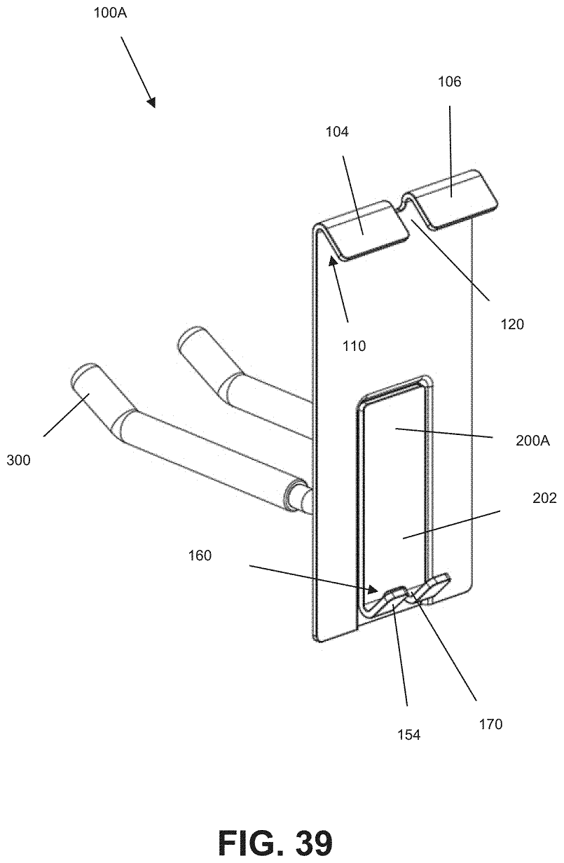

In some embodiments, for example, the bracket 102 is configurable in a retracted configuration, an extended configuration, and an intermediate configuration. In the retracted configuration, the spacing distance between the upper bracket-defined connection counterpart 104 and the lower bracket-defined connection counterpart 154 is a minimum spacing distance. In some embodiments, for example, the bracket member 1021, the locking mechanism 204, the slot 208, and the connection counterpart-defining configuration 200 are co-operatively configured such that, while the locking mechanism 204, for example, the threaded stud, is disposed at the upper terminal end of the slot 208, the bracket 102 is disposed in the retracted configuration. In some embodiments, for example, while the bracket 102 is disposed in the retracted configuration, the connection counterpart-defining configuration 200 is entirely disposed in the recess 206, for example, as depicted in FIG. 39. In the extended configuration, the spacing distance between the upper bracket-defined connection counterpart 104 and the lower bracket-defined connection counterpart 154 is a maximum spacing distance. In some embodiments, for example, the bracket member 1021, the locking mechanism 204, the slot 208, and the connection counterpart-defining configuration 200 are co-operatively configured such that, while the locking mechanism 204, for example, the threaded stud, is disposed at the lower terminal end of the slot 208, the bracket 102 is disposed in the extended configuration. In some embodiments, for example, while the bracket 102 is disposed in the extended configuration, at least a portion of the connection counterpart-defining configuration 200, for example, the portion including the lower bracket-defined connection counterpart 154, is disposed outside of the recess 206. In the intermediate configuration, the spacing distance between the upper bracket-defined connection counterpart 104 and the lower bracket-defined connection counterpart 154 is between the minimum spacing distance and the maximum spacing distance. In some embodiments, for example, the bracket member 1021, the locking mechanism 204, the slot 208, and the connection counterpart-defining configuration 200 are co-operatively configured such that, while the locking mechanism 204, for example, the threaded stud, is disposed between the upper terminal end and the lower terminal end of the slot 208, the bracket 102 is disposed in the intermediate configuration.

In some embodiments, for example, the minimum and maximum spacing distances between the upper bracket-defined connection counterpart 104 and the lower bracket-defined connection counterpart 154 is defined based on: 1) the length of the slot 208, 2) the position of the slot 208 on the flange 103, and 2) the length of the intermediate member 202.

In some embodiments, for example, the bracket member 1021 and the connection counterpart-defining configuration 200 are co-operatively configured such that the minimum spacing distance between the upper bracket-defined connection counterpart 104 and the lower bracket-defined connection counterpart 154 is 1 inch, and the maximum spacing distance between the upper bracket-defined connection counterpart 104 and the lower bracket-defined connection counterpart 154 is 12 inches.

In some embodiments, for example, for a given length of the slot 208, a decrease in length of the intermediate member 202 decreases the minimum and maximum spacing distances between the upper bracket-defined connection counterpart 104 and the lower bracket-defined connection counterpart 154, and an increase in length of the intermediate member 202 increases the minimum and maximum spacing distances between the upper bracket-defined connection counterpart 104 and the lower bracket-defined connection counterpart 154.

In some embodiments, for example, for a given length of the intermediate member 202, and for a slot 208 that extends from the bottom of the flange 103 in an upward direction, a decrease in length of the slot 208 increases the minimum spacing distance between the upper bracket-defined connection counterpart 104 and the lower bracket-defined connection counterpart 154, but does not increase the maximum spacing distance between the upper bracket-defined connection counterpart 104 and the lower bracket-defined connection counterpart 154, and an increase in length of the slot 208 decreases the minimum spacing distance between the upper bracket-defined connection counterpart 104 and the lower bracket-defined connection counterpart 154, but does not decrease the maximum spacing distance between the upper bracket-defined connection counterpart 104 and the lower bracket-defined connection counterpart 154.

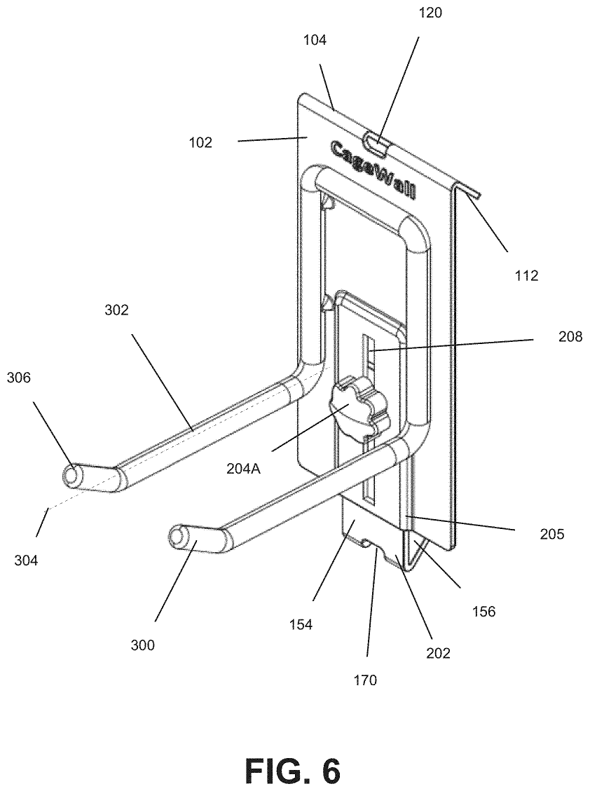

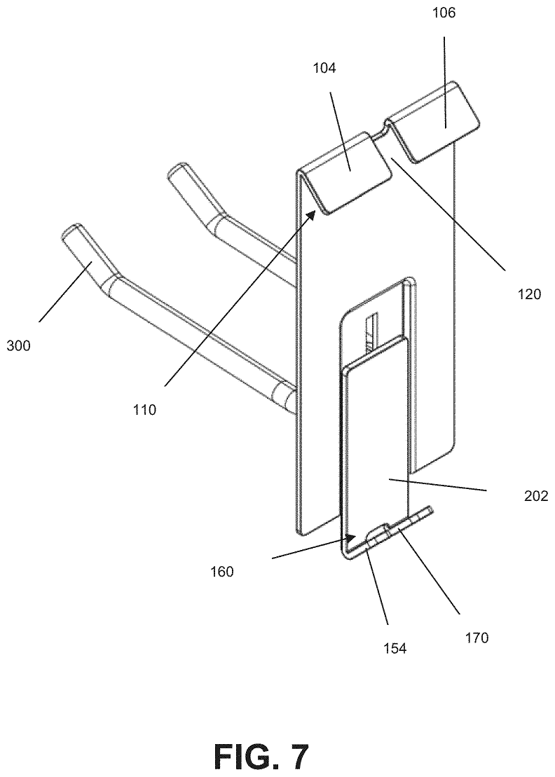

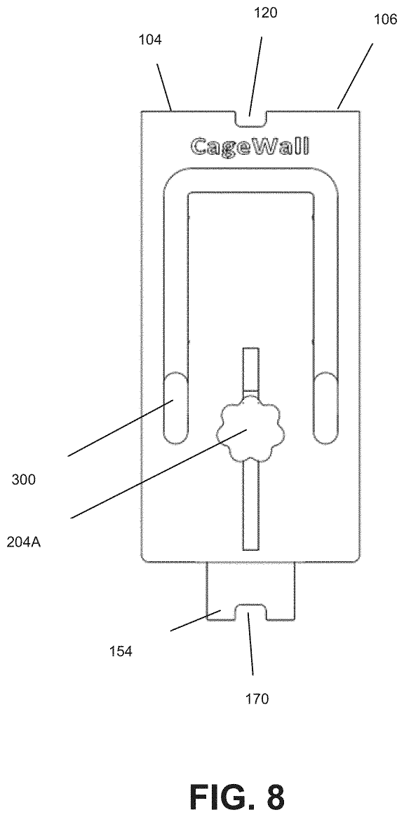

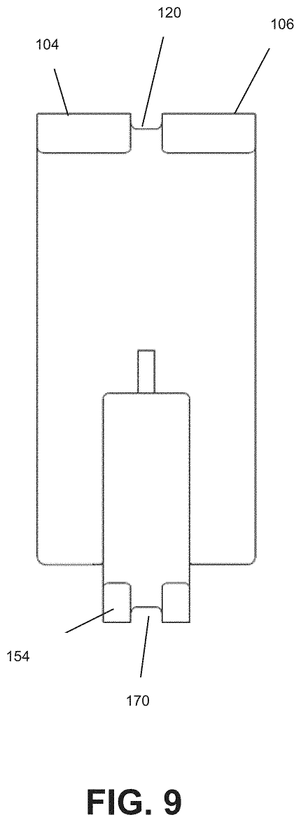

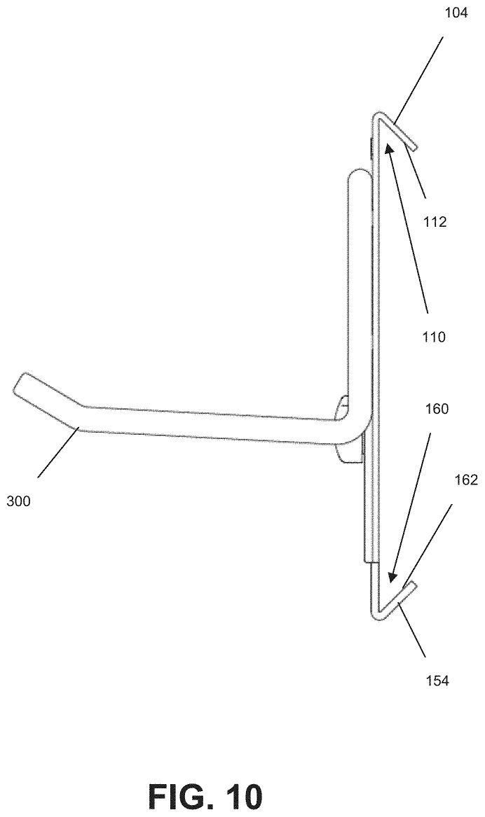

In some embodiments, for example, as depicted in FIG. 6 to FIG. 10, the mounting assembly 100 includes a load supporter 300. In some embodiments, for example, the load supporter 300 is connected to the bracket 102, for example, to the flange 103, by welding, mechanical fasteners, adhesives, and the like. The load supporter 300 includes a load-supporting portion 302, the load-supporting portion 302 configured to support a load, such as tires, storage boxes and bins, tools, sports equipment, outdoor equipment, lumber, clothes, appliances, pool accessories and toys, and the like. As depicted in FIG. 6 to FIG. 10, in some embodiments, for example the load supporter 300 includes two hooks. In some embodiments, for example, the load supporter 300 includes one hook. In some embodiments, for example, the load supporter 300 includes a ring from which a load is hung. In some embodiments, for example, the load supporter 300 includes a ring from which a load is received. In some embodiments, for example, the load supporter 300 includes a basket in which a load is received. In some embodiments, for example, the load supporter 300 includes a rod on which a load is supported, for example, a rod to hang clothes.

In some embodiments, for example, as depicted in FIG. 6 to FIG. 10, the load-supporting portion 302 extends outwardly, relative to the front surface 105 of the bracket 102. In some embodiments, for example, the load-supporting portion 302 extends outwardly, relative to the front surface 105 of the bracket 102, along a plane that is perpendicular to a plane defined by the front surface 105 of the bracket 102. In some embodiments, for example, the load-supporting portion 302 extends in a direction along an axis 304 that traverses a plane defined by the front surface 105 of the bracket 102. In some embodiments, for example, the traversing of the plane defined by the front surface 105 of the bracket 102 by the extension axis of the load-supporting portion 302 is such that the axis 304 is normal to the plane defined by the front surface 105 of the bracket 102. In some embodiments, for example, the traversing of the plane defined by the front surface 105 of the bracket 102 by the extension axis 304 of the load-supporting portion 302 is such that the axis 304 is angled relative to the plane defined by the front surface 105 of the bracket 102, the axis 304 and the plane defining an acute angle (e.g. the load supporting portion 302 extends from the flange 103 in a direction to the left or to the right). In some embodiments, for example, the acute angle defined between the axis 304 and the plane defined by the front surface 105 of the bracket 102 has a minimum value of at least 60 degrees.

In some embodiments, for example, the load-supporting portion 302 extends outwardly and in an upward direction, relative to the front surface 105 of the bracket 102. In this respect, in some embodiments, for example, the axis 304 is angled upwardly relative to a normal axis of the plane defined by the front surface 105 of the bracket 102, the axis 304 and the normal axis defining an acute angle therebetween. In some embodiments, for example, the acute angle defined between the axis 304 and the normal axis of the plane defined by the front surface 105 of the bracket 102 has a minimum value of at least 1 degree.

In some embodiments, for example, the load-supporting portion 302 extends outwardly and in a downward direction, relative to the front surface 105 of the bracket 102. In this respect, in some embodiments, for example, the axis 304 is angled downwardly relative to a normal axis of the plane defined by the front surface 105 of the bracket 102, the axis 304 and the normal axis defining an acute angle therebetween. In some embodiments, for example, the acute angle defined between the axis 304 and the normal axis of the plane defined by the front surface 105 of the bracket 102 has a maximum value of 5 degrees.

In some embodiments, for example, the load supporter 300 includes a load-retaining portion 306, configured to resist removal of a load that is supported by the load-supporting portion 302. As depicted in FIG. 6 to FIG. 10, the load-retaining portion 306 is angled relative to the load-supporting portion 302. In some embodiments, for example, the acute angle defined between load supporting portion 302 and the load-retaining portion 306 has a minimum value of at least 5 degrees. Due to the angled disposition of the load-retaining portion 306, relative to the load-supporting portion 302, while a load is supported by the load-supporting portion 302, if the load is displaced in a direction that is parallel to the axis 304, the load will engage the load-retaining portion 306, which will resist further displacement of the load in the direction that is parallel to the axis 304. To remove the load, the direction of displacement of the load is to be changed, in particular, to a direction along an axis of extension of the load-retaining portion 306, which is angled relative to the axis 304.

In some embodiments, for example, the mounting assembly 100 includes one bracket 102, and a load supporter 300, for example, one or more hooks, baskets, hanging rods, and the like, that is connected to the bracket 102. In such embodiments, for example, while the mounting assembly 100 is secured to a wire lattice 10, the load that is supported by the load supporter 300 is distributed to the wire lattice 10 via the bracket 102.

In some embodiments, for example, the mounting assembly 100 includes more than one bracket 102, and a load supporter 300, for example, one or more hooks, baskets, hanging rods, and the like, that is connected to the brackets 102. In such embodiments, for example, while the mounting assembly 100 is secured to a wire lattice 10, the load that is supported by the load supporter 300 is distributed to the wire lattice 10 via the plurality of brackets 102.

In some embodiments, for example, the mounting assembly 100 includes more than one bracket 102, and for each one of the brackets 102, independently, the bracket 102 is connected to a load supporter 300, for example, one or more hooks, baskets, hanging rods, and the like. In such embodiments, for example, while the mounting assembly 100 is secured to a wire lattice 10, the load that is supported by the load supporters 300 is distributed to the wire lattice 10 via the plurality of brackets 102.

In some embodiments, for example, the width of the upper bracket-defined connection counterpart 104 is wider than the width of the opening 20 of the wire lattice, measured along a horizontal axis. In a wire lattice configured in an upright configuration, the width of the opening 20 is the distance between two adjacent vertical sides of the opening 20, wherein the adjacent vertical sides are defined by adjacent vertical wires. In a wire lattice configured in an angled configuration, the width of the opening 20 is the distance between two opposing corners of the opening 20, wherein, for each corner of the opening 20, the corner is defined by a first wire and a second wire that intersects the first wire. For example, the upper wire 12 and the intersecting wire 16 intersect to define one of the corners of an opening of a wire lattice 10 configured in an angled configuration, as depicted in FIG. 29. In some embodiments, for example, one or more wires of the wire lattice 10 interferes with hanging the bracket 102 at a desired portion of the wire lattice 10.

In some embodiments, for example, the upper bracket-defined connection counterpart 104 defines a wire-receiving space 120, for example, an upper wire receiving space 120, that is configured to receive at least a portion of at least one of the plurality of wires of the wire lattice 10, such that the co-operative disposition of the hook 106 and the upper wire 12, of a wire lattice 10, in the hooked configuration, is effectible. In some embodiments, for example, the wire-receiving space 120 is configured to receive at least a portion of the intersecting wire 16, such that the co-operative disposition of the hook 106 and the upper wire 12, of a wire lattice 10 configured in the upright configuration or in the angled configuration, in the hooked configuration, is effectible. In some embodiments, for example, the wire-receiving space 120 is configured to receive at least a portion of the upper wire 12, such that the co-operative disposition of the hook 106 and the upper wire 12, of a wire lattice 10 configured in the upright configuration or in the angled configuration, in the hooked configuration, is effectible. In some embodiments, for example, the wire-receiving space 120 is configured to receive at least a portion of the intersecting wire 16 and at least a portion of the upper wire 12, such that the co-operative disposition of the hook 106 and the upper wire 12, of a wire lattice 10 configured in the upright configuration or in the angled configuration, in the hooked configuration is effectible.

In some embodiments, for example, the width of the upper wire-receiving space 120 has a minimum value of at least 0.3 inches.

In some embodiments, for example, the lower bracket-defined connection counterpart 154 defines a wire receiving space 170, for example, a lower wire receiving space 170, that is configured to receive at least a portion of at least one of the plurality of wires of the wire lattice 10, such that the disposition of the lower rotation-opposing configuration 156, relative to the lower wire 14, such that the lower rotation-opposing configuration 156 opposes rotation of the bracket 102, relative to the wire lattice 10, in the first direction and also in the second direction, is effectible. In some embodiments, for example, the wire-receiving space 170 is configured to receive at least a portion of the intersecting wire 16, such that the disposition of the lower rotation-opposing configuration 156, relative to the lower wire 14, such that the lower rotation-opposing configuration 156 opposes rotation of the bracket 102, relative to the wire lattice 10, in the first direction and also in the second direction, is effectible. In some embodiments, for example, the wire-receiving space 170 is configured to receive at least a portion of the lower wire 14, such that the disposition of the lower rotation-opposing configuration 156, relative to the lower wire 14, such that the lower rotation-opposing configuration 156 opposes rotation of the bracket 102, relative to the wire lattice 10, in the first direction and also in the second direction, is effectible. In some embodiments, for example, the wire-receiving space 170 is configured to receive at least a portion of a wire that intersects the lower wire 14, for example, an intersecting wire 18, as depicted in FIG. 29, such that the disposition of the lower rotation-opposing configuration 156, relative to the lower wire 14, such that the lower rotation-opposing configuration 156 opposes rotation of the bracket 102, relative to the wire lattice 10, in the first direction and also in the second direction, is effectible. In some embodiments, for example, the wire-receiving space 170 is configured to receive at least a portion of the lower wire 14 and at least a portion of a wire that intersects the lower wire 14, for example, the intersecting wire 18, such that the disposition of the lower rotation-opposing configuration 156, relative to the lower wire 14, such that the lower rotation-opposing configuration 156 opposes rotation of the bracket 102, relative to the wire lattice 10, in the first direction and also in the second direction, is effectible.

In some embodiments, for example, the width of the lower wire-receiving space 170 has a minimum value of at least 0.3 inches.

In some embodiments, for example, the intersecting wire 16 is offset from and the intersecting wire 18, for example, disposed to the left or to the right of the intersecting wire 18. In some embodiments, for example, the upper wire 12 extends along the first axis, the lower wire 14 extends along the second axis, the intersecting wire 16 extends along the third axis, and the intersecting wire 18 extends along a fourth axis. In some embodiments, for example, the first axis and the second axis are parallel. In some embodiments, for example, the first axis and the second axis are non-parallel. In some embodiments, for example, the first axis and the fourth axis are non-parallel. In some embodiments, for example, the second axis and the fourth axis are non-parallel. In some embodiments, for example, the first axis and the fourth axis are perpendicular. In some embodiments, for example, the second axis and the fourth axis are perpendicular. In some embodiments, for example, the third axis and the fourth axis are parallel. In some embodiments, for example, the third axis and the fourth axis are non-parallel.

To connect the bracket 102 to a wire lattice 10 configured in an upright configuration, as depicted in FIG. 14 to FIG. 28, the spacing of the upper bracket-defined connection counterpart 104 and the lower bracket-defined connection counterpart 154 is adjusted to the rotation permissive spacing. Then, the hook 106 and the upper wire 12 are co-operatively disposed in the hooked configuration to hang the bracket 102 from the upper wire 12, such that the bracket 102 and the wire lattice 10 are co-operatively disposed in the rotation permissive configuration. As depicted in FIG. 14 to FIG. 18, the hooking of the bracket 102 to the upper wire 12 is effected by disposition of at least a portion of the upper wire 12 into the upper channel 110. As depicted, in some embodiments, for example, at least a portion of the intersecting wire 16 is received in the wire-receiving space 120 of the upper bracket-defined connection counterpart 104 to effect the co-operative disposition of the hook 106 and the upper wire 12 in the hooked configuration. As depicted, while at least a portion of the intersecting wire 16 is received in the wire-receiving space 120, the hook member 108 is received in and extends through a pair of adjacent openings 20 of the wire lattice 10. With the bracket 102 hanging from the upper wire 12, the bracket 102 is rotated, relative to the wire lattice 10, such that the rear surface 107 opposes the wire lattice 10. Such rotation of the bracket 102, relative to the wire lattice 10, is with effect that at least another portion of the intersecting wire 16, for example, a portion of the intersecting wire 16 that is disposed below the portion of the intersecting wire 16 received in the wire-receiving space 120, is received in the wire-receiving space 170 of the lower bracket defined connection counterpart 154, as depicted in FIG. 14 to FIG. 18. While at least the another portion of the intersecting wire 16 is received in the wire-receiving space 170, the lower rotation-opposing configuration member 158 is received in and extends through another pair of adjacent openings 20 of the wire lattice 10. At this point, the bracket 102 is hanging from the wire lattice 10, wherein the bracket 102 is vertically supported by the wire lattice 10, for example, by the upper wire 12, and displacement of the bracket 102, relative to the wire lattice 10, in a direction away from the wire lattice 10, is opposed.

To secure the bracket 102 to the wire lattice 10 in the upright configuration, the spacing of the upper bracket-defined connection counterpart 104 and the lower bracket-defined connection counterpart 154, while the bracket 102 is hanging from the upper wire 12, is adjusted, for example, decreased, from the rotation permissive spacing to the rotation resistant spacing, as depicted in FIG. 19 to FIG. 23, such that the bracket 102 and the wire lattice become co-operatively disposed in the rotation resistant configuration. Such adjustment of the spacing between the upper bracket-defined connection counterpart 104 and the lower bracket-defined connection counterpart 154, while the bracket 102 is hanging from the upper wire 12, from the rotation permissive spacing to the rotation resistant spacing, is with effect that the bracket 102 is gripping the wire lattice 10. In some embodiments, for example, the adjusting of the spacing between the upper bracket-defined connection counterpart 104 and the lower bracket-defined connection counterpart 154 to the rotation-resistant spacing, while the hook 106 and the upper wire 12 are disposed in the hooked configuration, is with effect that the lower rotation-opposing configuration 156 is disposed relative to the lower wire 14, such that the lower rotation-opposing configuration 156 opposes rotation of the bracket 102, relative to the wire lattice 10, in the first direction (e.g. towards the wire lattice 10), and also opposes rotation of the bracket 102, relative to the wire lattice 10, in the second direction (e.g. away from the wire lattice 10), wherein the first direction is opposite to the second direction. In some embodiments, for example, the adjusting of the spacing between the upper bracket-defined connection counterpart 104 and the lower bracket-defined connection counterpart 154 to the rotation-resistant spacing, while the hook and the upper wire are disposed in the hooked configuration, is with effect that at least a portion of the lower wire 14 is disposed in the lower channel 160 of the lower bracket-defined connection counterpart 154. While: (i) the bracket 102 is hung from the upper wire 12, and (ii) at least a portion of the lower wire 14 is disposed in the lower channel 160, the lower-bracket defined connection counterpart 154 and the lower wire 14 are co-operatively configured to resist rotation of the bracket 102, relative to the wire lattice 10, in the first direction and also in the second direction.

In some embodiments, for example, while the spacing between the upper bracket-defined connection counterpart 104 and the lower bracket-defined connection counterpart 154 is the rotation resistant spacing, the bracket 102 is disposed in the intermediate configuration.

At this point, while the bracket 102 and the wire lattice 10 are co-operatively disposed in rotation-resistant configuration, the bracket 102 is disposed in the fixed configuration, for example, via actuation of the locking mechanism 204, to secure the bracket 102 to the wire lattice 10. In some embodiments, for example, while the bracket 102 is secured to the wire lattice 10, rotation of the bracket 102, relative to the wire lattice 10, in the first direction and in the second direction, is resisted. In some embodiments, for example, by resisting rotation of the bracket 102 relative to the wire lattice 10, the securing of the bracket 102 to the wire lattice 10 secures the retention of the bracket 102 to the wire lattice 10, and resists disconnection, for example, accidental or unintentional disconnection, of the bracket 102 from the wire lattice 10.

FIG. 24 to FIG. 28 depict the mounting assembly 100 having the bracket 102 and the load supporter 300 secured to a wire lattice 10 configured in an upright configuration. In some embodiments, for example, while the bracket 102 is secured to the wire lattice 10, a load is supportable by the load supporting portion 302 of the load supporter 300, such that the load supported by the load supporter 300 is supported by the wire lattice 10 via the bracket 102 that is secured to the wire lattice 10.

As depicted in FIG. 14 to FIG. 28: (i) a portion of the intersecting wire 16 is received in the wire receiving space 120, and the hook member 108 is received in and extends through a pair of adjacent openings 20 of the wire lattice 10, to effect the co-operatively disposition of the hook 106 and the upper wire 12 in the hanging configuration, and (ii) another portion of the intersecting wire 16 is received in the wire receiving space 170, and the lower rotation-opposing configuration member 158 is received in and extends through another pair of adjacent openings 20 of the wire lattice 10, to effect the disposition of the lower rotation-opposing configuration 156, relative to the lower wire 14, such that the lower rotation-opposing configuration 156 opposes rotation of the bracket 102, relative to the wire lattice, in the first direction and also in the second direction. In some embodiments, for example, the hook member 108 is receivable and extendible through a single opening 20 of the wire lattice 10, without receiving a portion of the intersecting wire 16 in the wire receiving space 120, to effect the co-operatively disposition of the hook 106 and the upper wire 12 in the hooked configuration. In some embodiments, for example, the lower rotation-opposing configuration member 158 is receivable in and extendible through another single opening 20 of the wire lattice 10, without receiving a portion of the intersecting wire 16 in the wire receiving space 170, to effect the disposition of the lower rotation-opposing configuration 156, relative to the lower wire 14, such that the lower rotation-opposing configuration 156 opposes rotation of the bracket 102, relative to the wire lattice, in the first direction and also in the second direction.

In some embodiments, for example, to release the bracket 102 from the wire lattice 10, the bracket 102 is disposed from the fixed configuration to the adjustable configuration, for example, via actuation of the locking mechanism 204, and the spacing between the upper bracket-defined connection counterpart 104 and the lower bracket-defined connection counterpart 154 is adjusted, for example, increased, to the rotation permissive spacing, such that the bracket 12 and the wire lattice become co-operatively disposed in the rotation permissive configuration, and rotation of the bracket 102, relative to the lattice 10, is effectible. Such adjustment of the spacing between the upper bracket-defined connection counterpart 104 and the lower bracket-defined connection counterpart 154, while the bracket 102 is hanging from the upper wire 12, from the rotation resistant spacing to the rotation permissive spacing, is with effect that the bracket 102 is no longer gripping the wire lattice 10. At this point, the bracket 102 is released from retention from the lattice 10, for example, by rotating the bracket 102 away from the wire lattice 10 and unhooking the bracket 102 from the wire lattice 10. In some embodiments, for example, while the bracket 102 is released from the lattice 10, the bracket 102 is repositionable to another part of the wire lattice 10 and hangable and securable to the wire lattice 10 at said another part of the wire lattice 10, or is repositionable to another wire lattice 10 and hangable and securable to said another wire lattice 10.

To connect the bracket 102 to a wire lattice 10 configured in an angled configuration, as depicted in FIG. 29 to FIG. 36, the spacing of the upper bracket-defined connection counterpart 104 and the lower bracket-defined connection counterpart 154 is adjusted to the rotation permissive spacing. Then, the hook 106 and the upper wire 12 are co-operatively disposed in the hooked configuration to hang the bracket 102 from the wire lattice 10, for example, from at least the upper wire 12, such that the bracket 102 and the wire lattice 10 are co-operatively disposed in the rotation permissive configuration. As depicted in FIG. 29 to FIG. 36, the hooking of the bracket 102 to the upper wire 12 is effected by disposition of at least a portion of the upper wire 12 into the upper channel 110. As depicted, in some embodiments, for example, at least a portion of the upper wire 12 and at least a portion of the intersecting wire 16 are received in the wire-receiving space 120 of the upper bracket-defined connection counterpart 104 to effect the co-operative disposition of the hook 106 and the wire lattice 10, for example, the upper wire 12 and the intersecting wire 16, in the hooked configuration. As depicted, while at least a portion of the upper wire 12 and at least a portion of the intersecting wire 16 are received in the wire-receiving space 120, the hook member 108 is received in and extends through a pair of adjacent openings 20 of the wire lattice 10. With the bracket 102 hanging from the wire lattice 10, the bracket 102 is rotated, relative to the wire lattice 10, such that the rear surface 107 opposes the wire lattice 10. Such rotation of the bracket 102, relative to the wire lattice 10, is with effect that the lower rotation-opposing configuration is received in an opening 20 of the wire lattice, as depicted in FIG. 29 to FIG. 32. At this point, the bracket 102 is hanging from the wire lattice 10, wherein the bracket 102 is vertically supported by the wire lattice 10, for example, by the upper wire 12, and displacement of the bracket 102, relative to the wire lattice 10, in a direction away from the wire lattice 10, is opposed.

To secure the bracket 102 to the wire lattice 10 in the angled configuration, the spacing of the upper bracket-defined connection counterpart 103 and the lower bracket-defined connection counterpart 154, while the bracket 102 is hanging from the upper wire 12, is adjusted, for example, decreased, from the rotation permissive spacing to the rotation resistant spacing, as depicted in FIG. 33 to FIG. 36, such that the bracket 102 and the wire lattice become co-operatively disposed in the rotation resistant configuration. Such adjustment of the spacing between the upper bracket-defined connection counterpart 104 and the lower bracket-defined connection counterpart 154, while the bracket 102 is hanging from the wire lattice 10, from the rotation permissive spacing to the rotation resistant spacing, is with effect that the bracket 102 is gripping the wire lattice 10. In some embodiments, for example, the adjusting of the spacing between the upper bracket-defined connection counterpart 104 and the lower bracket-defined connection counterpart 154 to the rotation-resistant spacing, while the hook 106 and the wire lattice 10, for example, at least the upper wire 12, are disposed in the hooked configuration, is with effect that the lower rotation-opposing configuration 156 is disposed relative to the lower wire 14, such that the lower rotation-opposing configuration 156 opposes rotation of the bracket 102, relative to the wire lattice 10, in the first direction (e.g. towards the wire lattice 10), and also opposes rotation of the bracket 102, relative to the wire lattice 10, in the second direction (e.g. away from the wire lattice 10), wherein the first direction is opposite to the second direction. In some embodiments, for example, the adjusting of the spacing between the upper bracket-defined connection counterpart 104 and the lower bracket-defined connection counterpart 154 to the rotation-resistant spacing, while the hook 106 and the wire lattice 10, for example, at least the upper wire 12, are disposed in the hooked configuration, is with effect that at least a portion of the lower wire 14 is disposed in the lower channel 160 of the lower bracket-defined connection counterpart 154. While: (i) the bracket 102 is hung from the upper wire 12, and (ii) at least a portion of the lower wire 14 is disposed in the lower channel 160, the lower-bracket defined connection counterpart 154 and the lower wire 14 are co-operatively configured to resist rotation of the bracket 102, relative to the wire lattice 10, in the first direction and also in the second direction. In some embodiments, for example, the adjusting of the spacing between the upper bracket-defined connection counterpart 104 and the lower bracket-defined connection counterpart 154 to the rotation-resistant spacing. while the hook 106 and the wire lattice 10, for example, at least the upper wire 12, are disposed in the hooked configuration, is with effect that at least a portion of the lower wire 14 and at least a portion of the intersecting wire 18 are disposed in the lower channel 160 of the lower bracket-defined connection counterpart 154, as depicted in FIG. 33 to FIG. 36. While: (i) the bracket 102 is hung from the upper wire 12, and (ii) at least a portion of the lower wire 14 and at least a portion of the intersecting wire 18 are disposed in the lower channel 160, the lower-bracket defined connection counterpart 154, the lower wire 14, and the intersecting wire 16 are co-operatively configured to resist rotation of the bracket 102, relative to the wire lattice 10, in the first direction and also in the second direction.

At this point, while the bracket 102 and the wire lattice 10 are co-operatively disposed in rotation-resistant configuration, the bracket 102 is disposed in the fixed configuration, for example, via actuation of the locking mechanism 204, to secure the bracket 102 to the wire lattice 10. In some embodiments, for example, while the bracket 102 is secured to the wire lattice 10, rotation of the bracket 102, relative to the wire lattice 10, in the first direction and in the second direction, is resisted. In some embodiments, for example, by resisting rotation of the bracket 102 relative to the wire lattice 10, the securing of the bracket 102 to the wire lattice 10 secures the retention of the bracket 102 to the wire lattice 10, and resists disconnection, for example, accidental or unintentional disconnection, of the bracket 102 from the wire lattice 10.

FIG. 33 to FIG. 36 depict the mounting assembly 100 having the bracket 102 and the load supporter 300 secured to a wire lattice 10 configured in an angled configuration. In some embodiments, for example, while the bracket 102 is secured to the wire lattice 10, a load is supportable by the load supporting portion 302 of the load supporter 300, such that the load supported by the load supporter 300 is supported by the wire lattice 10 via the bracket 102 that is secured to the wire lattice 10.

As depicted in FIG. 29 to FIG. 36: (i) a portion of the upper wire 12 and a portion of the intersecting wire 16 are received in the wire receiving space 120, and the hook member 108 is received in and extends through a pair of adjacent openings 20 of the wire lattice 10, to effect the co-operatively disposition of the hook 106 and the wire lattice 10 in the hanging configuration, and (ii) there is absence of disposition of a wire in the wire receiving space 170, to effect the disposition of the lower rotation-opposing configuration 156, relative to the lower wire 14, such that the lower rotation-opposing configuration 156 opposes rotation of the bracket 102, relative to the wire lattice, in the first direction and also in the second direction. In some embodiments, for example, the hook member 108 is receivable and extendible through a single opening 20 of the wire lattice 10, wherein: (i) at least a portion of the upper wire 12 and at least a portion of the intersecting wire 16 are disposed in the upper channel 110, and (ii) there is an absence of disposition of wires in the wire receiving space 120, to effect the co-operatively disposition of the hook 106 and the upper wire 12 in the hanging configuration. In some embodiments, for example, at least a portion of the lower wire 14 is receivable in the wire receiving space 170, and the lower rotation-opposing configuration member 158 is receivable in and extendible through a pair of adjacent openings 20, to effect the disposition of the lower rotation-opposing configuration 156, relative to the lower wire 14, such that the lower rotation-opposing configuration 156 opposes rotation of the bracket 102, relative to the wire lattice 10, in the first direction and also in the second direction. In some embodiments, for example, at least a portion of the lower wire 14 and at least a portion of the intersecting wire 18 are receivable in the wire receiving space 170, and the lower rotation-opposing configuration member 158 is receivable in and extendible through a pair of adjacent openings 20, to effect the disposition of the lower rotation-opposing configuration 156, relative to the lower wire 14 and the intersecting wire 18, such that the lower rotation-opposing configuration 156 opposes rotation of the bracket 102, relative to the wire lattice 10, in the first direction and also in the second direction.

In some embodiments, for example, to release the bracket 102 from the wire lattice 10, the bracket 102 is disposed from the fixed configuration to the adjustable configuration, for example, via actuation of the locking mechanism 204, and the spacing between the upper bracket-defined connection counterpart 104 and the lower bracket-defined connection counterpart 154 is adjusted, for example, increased, to the rotation permissive spacing, such that the bracket 12 and the wire lattice 10 become co-operatively disposed in the rotation permissive configuration, and rotation of the bracket 102, relative to the lattice 10, is effectible. Such adjustment of the spacing between the upper bracket-defined connection counterpart 104 and the lower bracket-defined connection counterpart 154, while the bracket 102 is hanging from the wire lattice 10, for example, from at least the upper wire 12, from the rotation resistant spacing to the rotation permissive spacing, is with effect that the bracket 102 is no longer gripping the wire lattice 10. At this point, the bracket 102 is released from retention from the lattice 10, for example, by rotating the bracket 102 away from the wire lattice 10 and unhooking the bracket 102 from the wire lattice 10. In some embodiments, for example, while the bracket 102 is released from the lattice 10, the bracket 102 is repositionable to another part of the wire lattice 10 and hangable and securable to the wire lattice 10 at said another part of the wire lattice 10, or is repositionable to another wire lattice 10 and hangable and securable to said another wire lattice 10.

Accordingly, the spacing distance between the upper bracket-defined connection counterpart 104 and the lower bracket-defined connection counterpart 154 is adjustable such that the bracket 102 is hangable and securable to a pair of wires, the pair of wires including an upper wire and a lower wire, of a wire lattice 10 configured in an upright configuration, for example, as depicted in FIG. 14 to FIG. 28, and such that the bracket 102 is also hangable and securable to a pair of wires, the pair of wires including an upper wire and a lower wire, of a wire lattice 10 configured in an angled configuration, for example, as depicted in FIG. 29 to FIG. 36. The bracket 102 is also repositionable to another portion of the wire lattice 10 for hanging from and securing to said another apportion of the wire lattice 10. The bracket 102 is also repositionable to another wire lattice 10 for hanging from and securing to said another wire lattice 10.

In some embodiments, for example, the material of manufacture of the bracket 102 includes steel.

In some embodiments, for example, the hanging and securing of the bracket 102 to the wire lattice 10 is effectible without the use of fasteners, for example, mechanical fasteners, such as screws, nuts and bolts, pins, nails, and the like.

In some embodiments, for example, it is desirable to change the minimum spacing distance and maximum spacing distance between the upper bracket-defined connection counterpart 104 and the lower bracket-defined connection counterpart 154, for example, based on the spacing between the wires of a wire lattice 10, to which the assembly 100 is to be mounted.

In such embodiments, for example, the connection counterpart-defining configuration 200 is disconnected from the bracket member 1021, for example, the flange 103, by decoupling the rotatable head 204A of the locking mechanism 204 from the threaded stud that is connected to the connection counterpart-defining configuration 200. At this point, the connection between the bracket member 1021 and the connection counterpart-defining configuration 200 is defeated, and the connection counterpart-defining configuration 200 is separated from the bracket member 1021. Then, another connection counterpart-defining configuration 200, having an intermediate member 202 of suitable length, is connected to the bracket member 1021, for example, the flange 103. To connect the another connection counterpart-defining configuration 200 to the bracket member 1021, the threaded stud is received through the slot 208 of the flange 103, and the rotatable head 204A is connected to the threaded stud of the another connection counterpart-defining configuration 200. At this point, the bracket member 1021 and the another connection counterpart-defining configuration 200 is releasably coupled, and the bracket 102 is defined.

Accordingly, the bracket member 1021 is releasably couplable to the connection counterpart-defining configuration 200, and also releasably couplable to the another connection counterpart-defining configuration 200, for defining the bracket 102.

Accordingly, if it is desirable to connect and secure the mounting assembly 100 to a wire lattice 10 having a pair of wires spaced apart by a first spacing distance, but the spacing between the upper bracket-defined connection counterpart 104 and the lower bracket-defined connection counterpart 154 is not adjustable to correspond to the first spacing distance between the pair of wires, the connection counterpart-defining configuration 200 can be decoupled from the bracket member 1021, and another connection counterpart-defining configuration 200 of suitable length can be coupled to the bracket member 1021, such that the spacing between the upper bracket-defined connection counterpart 104 and the lower bracket-defined connection counterpart 154 can be adjusted to correspond to the spacing distance between the pair of wires, for connecting and securing the assembly 100 to the wire lattice 10. In this respect, the same bracket member 1021 and locking mechanism 204 (e.g. rotatable head 204A and threaded stud) are used, and different embodiments of the connection counterpart-defining configuration 200, having different lengths of the intermediate member 202, can be connected to the bracket member 1021 via the locking mechanism 204, to define the bracket 102, and to connect the bracket 102 to the wires of the desired wire lattice 10.

In some embodiments, for example, the mounting assembly 100 includes one bracket member 1021, and a load supporter 300, for example, one or more hooks, baskets, hanging rods, and the like, that is connected to the flange 103, wherein more than one connection counterpart-defining configuration 200 is releasably coupled to the bracket member 1021. In such embodiments, for example, for each one of the plurality of connection counterpart-defining configurations 200, independently, the flange 103 defines a recess 206 for receiving the intermediate member 202, and further defines a slot 208 for receiving the threaded stud of the connection counterpart-defining configuration 200 and defining the minimum and maximum spacing distances between the upper bracket-defined connection counterpart 104 and a lower bracket-defined connection counterpart 154 of the connection counterpart-defining configuration 200, and further includes a rotatable head 204A co-operable with the threaded stud for releasably coupling the connection counterpart-defining configuration 200 to the bracket member 1021. In such embodiments, for example, while the mounting assembly 100 is secured to wire lattice 10, the load that is supported by the load supporter 300 is distributed to the wire lattice 10 via the bracket 102.

In some embodiments, for example, each one of the upper wire receiving space 120 and the plurality of lower wire receiving spaces 170, independently, is configured to receive at least a portion of one or more wires of the wire lattice 10 to defeat the interference of said wires, for hanging and securing the bracket 102 to the wire lattice 10, such that the bracket 102 is hangable and securable to a position of the wire lattice 10 as desired by a user. In some embodiments, for example, each one of the upper wire receiving space 120 and at least one of the plurality of lower wire receiving spaces 170, independently, is configured to receive at least a portion of the intersecting wire 16, to defeat the interference of the intersecting wire 16, for hanging and securing the bracket 102 to the wire lattice 10, such that the bracket 102 is hangable and securable to a portion of the wire lattice 10 as desired by a user. In some embodiments, for example, the upper wire receiving space 120 is configured to receive at least a portion of the intersecting wire 16 and at least one of the plurality of lower wire receiving spaces 170 is configured to receive at least a portion of the intersecting wire 18, to defeat the interference of the intersecting wire 16 and the intersecting wire 18, for hanging and securing the bracket 102 to the wire lattice 10, such that the bracket 102 is hangable and securable to a portion of the wire lattice 10 as desired by a user.

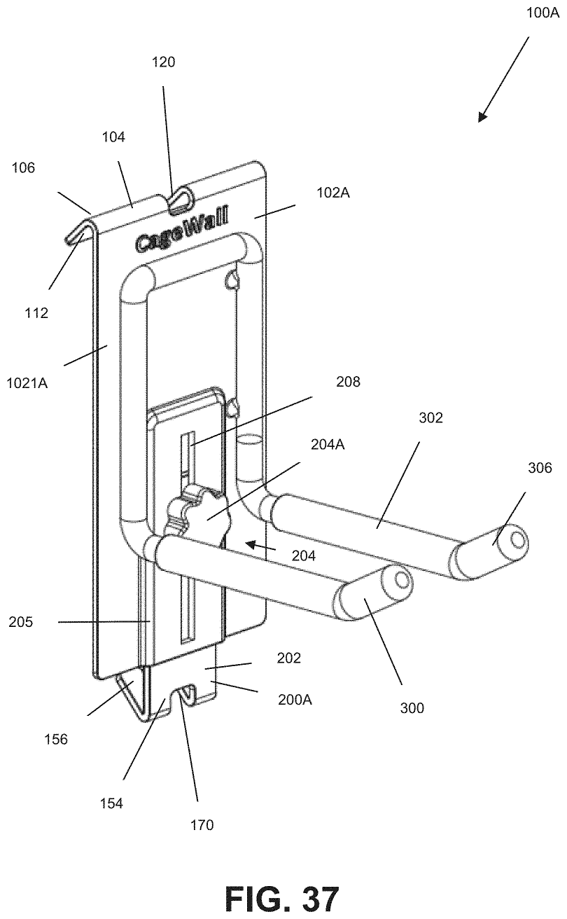

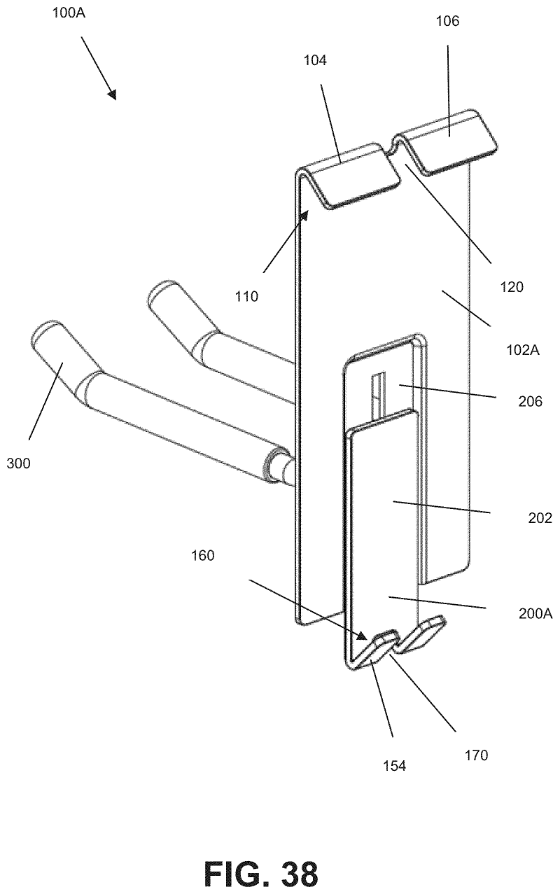

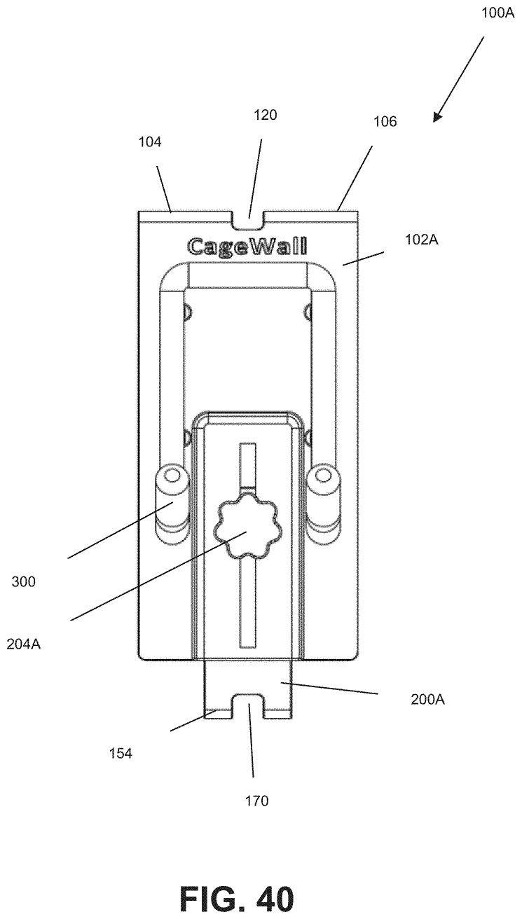

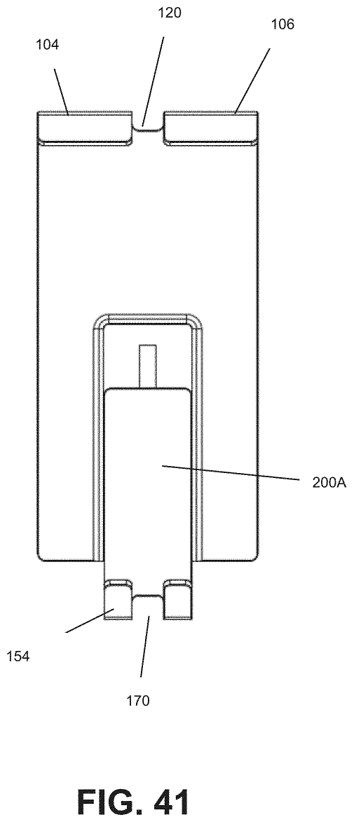

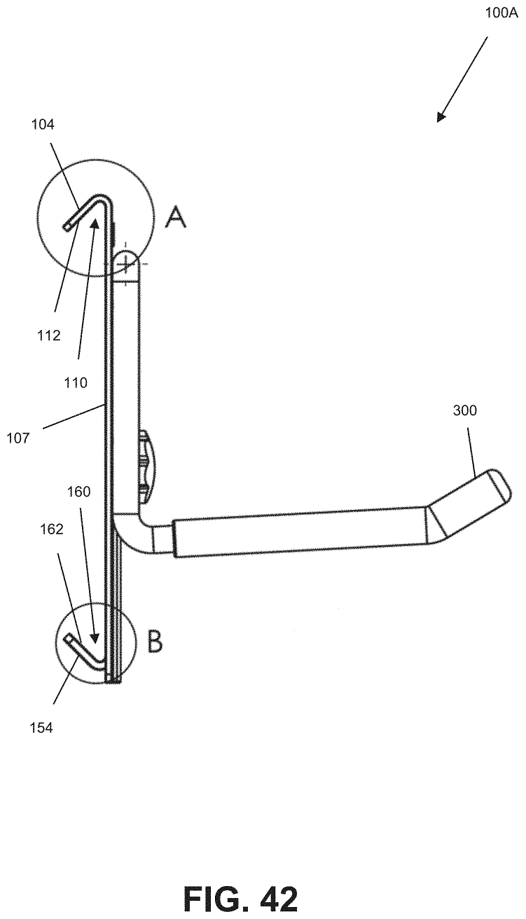

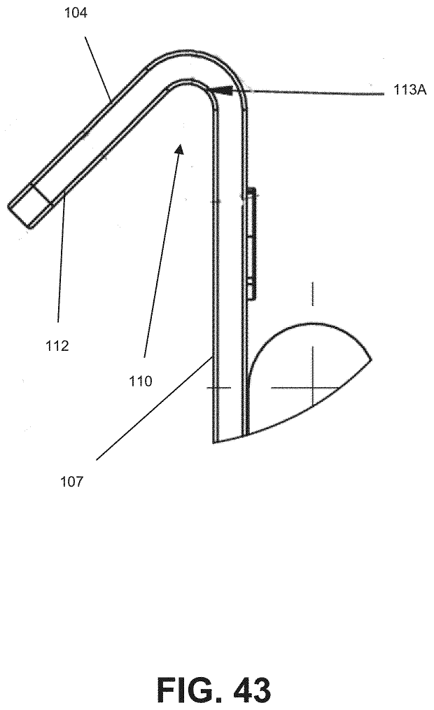

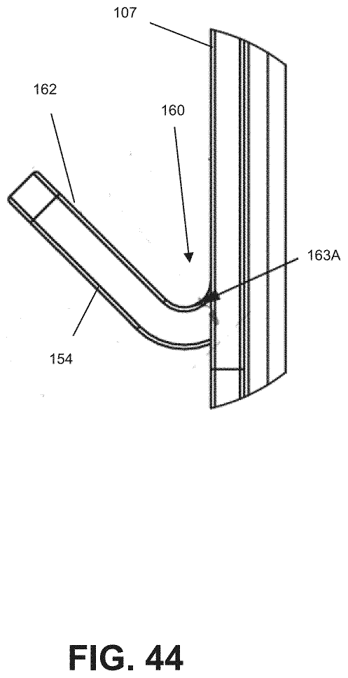

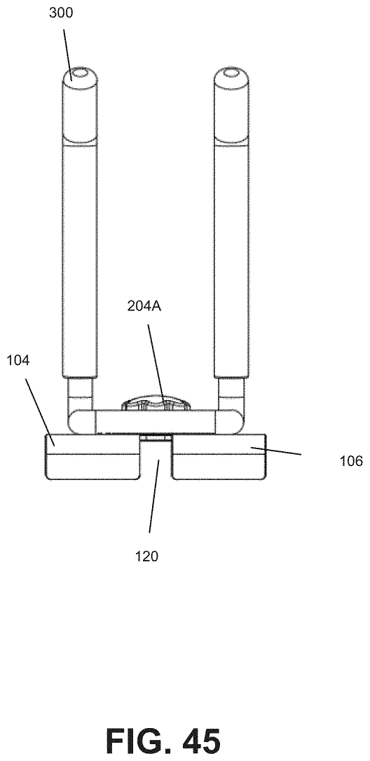

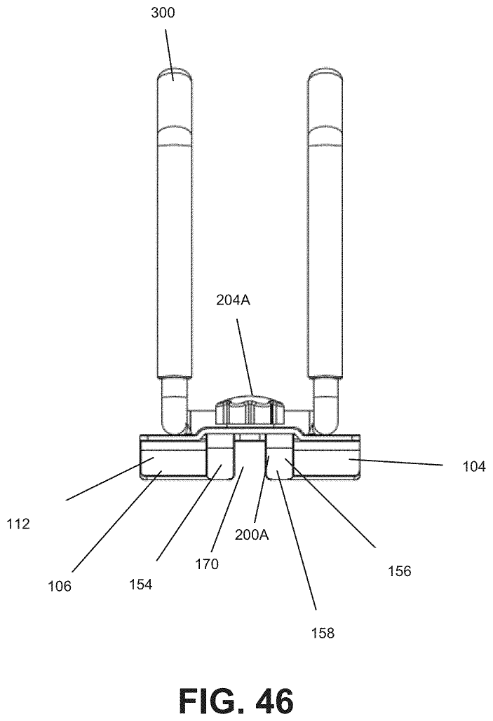

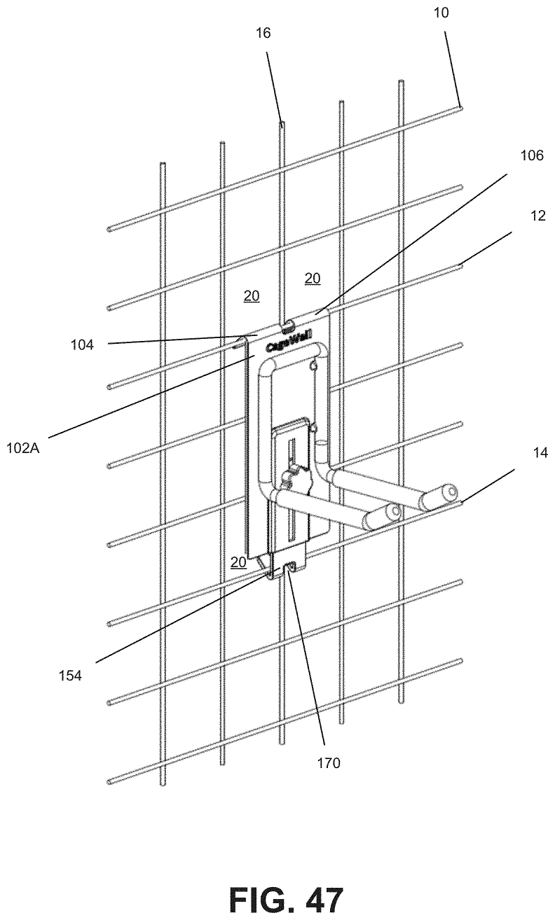

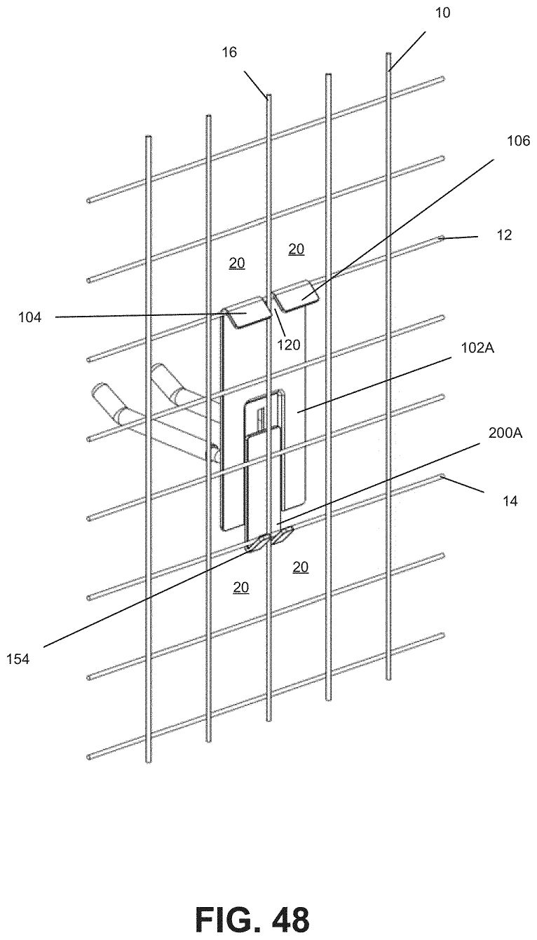

FIG. 37 to FIG. 48 depict a mounting assembly 100A that is an alternate embodiment of the mounting assembly 100. The assembly 100A substantially corresponds to the assembly 100 as depicted in FIG. 6, except, as depicted in FIG. 42 to 44: (i) the internal curved surface 113A of the of the bracket member 1021A of the bracket 102A of the assembly 100A is greater than the internal curved surface 113 of the of the bracket member 1021 of the bracket 102 of the assembly 100, and (ii) the internal curved surface 163A of the connection counterpart-defining configuration 200A of the bracket 102A of the assembly 100A is greater than the internal curved surface 163 of the connection counterpart-defining configuration 200 of the bracket 102 of the assembly 100.

By increasing the radius of curvature of the internal curved surface 113A, relative to the internal curved surface 113, the maximum radius of the upper wire 12, from which the assembly 100, for example, the bracket 102A, is hangable, such that the upper wire 12 is disposed in contact engagement with the internal curved surface 113A, is increased. In some embodiments, for example, the internal curved surface 113A of the bracket 102A of the assembly 100A has a radius of curvature of 0.125″. In some embodiments, for example, while the radius of curvature of the curved surface 113A is 0.125″, the assembly 100A, for example, the bracket 102A, is hangable from an upper wire 12 having a radius of 0.125″ or less, such that, while the assembly 100A is hung from the upper wire 12, the upper wire 12 is disposed in contact engagement with the internal curved surface 113A. In some embodiments, for example, the connection between the bracket 102A and the upper wire 12, for example, the hanging of the bracket 102A from the upper wire 12, is improved while the upper wire 12 is disposed in contact engagement with the internal curved surface 113A, which reduces the risk of unintentional disconnection of the assembly 100A from the wire lattice 10.

By increasing the radius of curvature of the internal curved surface 163A, relative to the internal curved surface 163, the maximum radius of the lower wire 14, to which the assembly 100A is securable while the assembly 100A is hanging from the upper wire 12, such that the lower wire 14 is disposed in contact engagement with the internal curved surface 163A, is increased. In some embodiments, for example, the internal curved surface 163A of the bracket 102A of the assembly 100A has a radius of curvature of 0.125″. In some embodiments, for example, while the radius of curvature of the curved surface 163A is 0.125″, the connection of the assembly 100A and the wire lattice 10 is securable via co-operative configuration of the lower rotation-opposing configuration 156 and a lower wire 14 having a radius of 0.125″ or less, such that, while the connection of the assembly 100A and the wire lattice 10 is secured via co-operative configuration of the lower rotation-opposing configuration 156 and the lower wire 14, the lower wire 14 is disposed in contact engagement with the internal curved surface 163A. In some embodiments, for example, the securing of the connection between the assembly 100A and the wire lattice 10 is improved while the lower wire 14 is disposed in contact engagement with the internal curved surface 163A, which reduces the risk of unintentional disconnection of the lower rotation-opposing configuration 156 from the lower wire 14 or unintentional displacement of the assembly 100A relative to the wire lattice.

The mounting assembly 100A can be connected to, and secured to, a wire lattice 10, similar to the manner by which the connection and securing between the mounting assembly 100 to the wire lattice 10, is established.

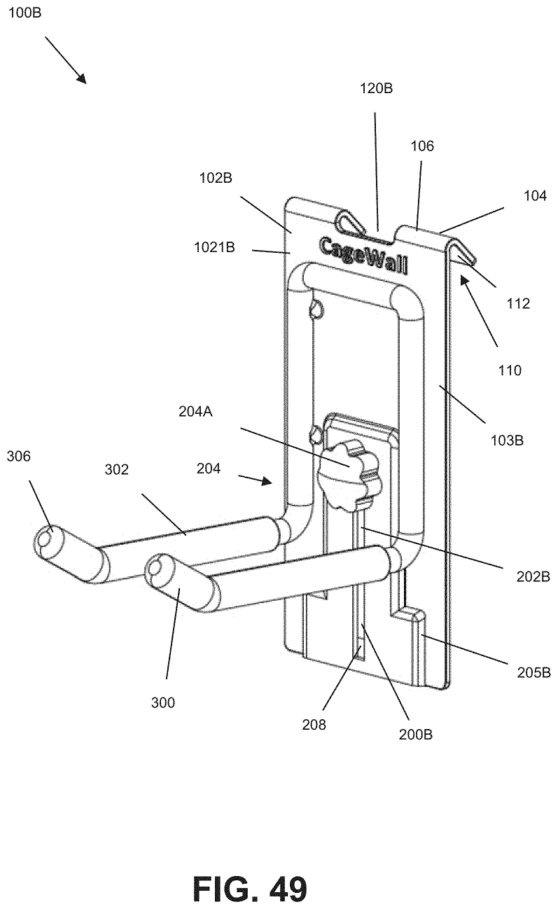

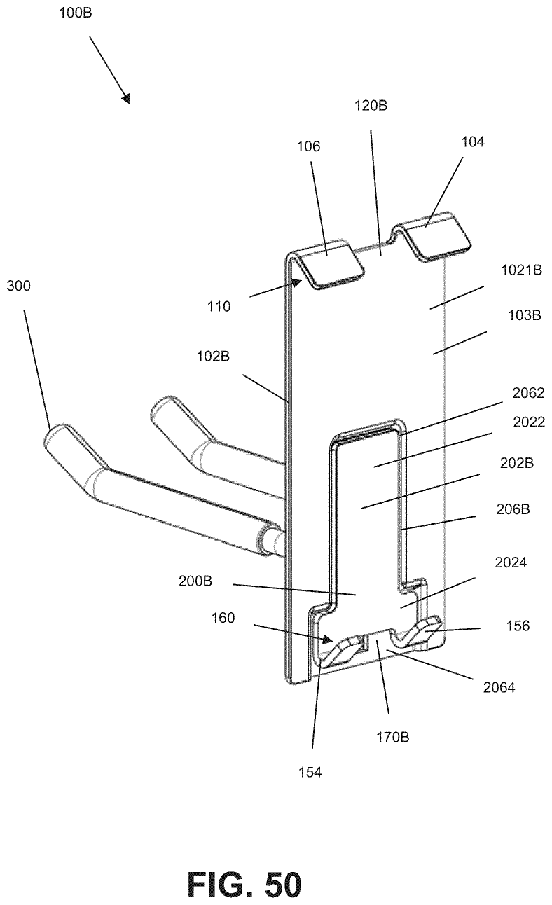

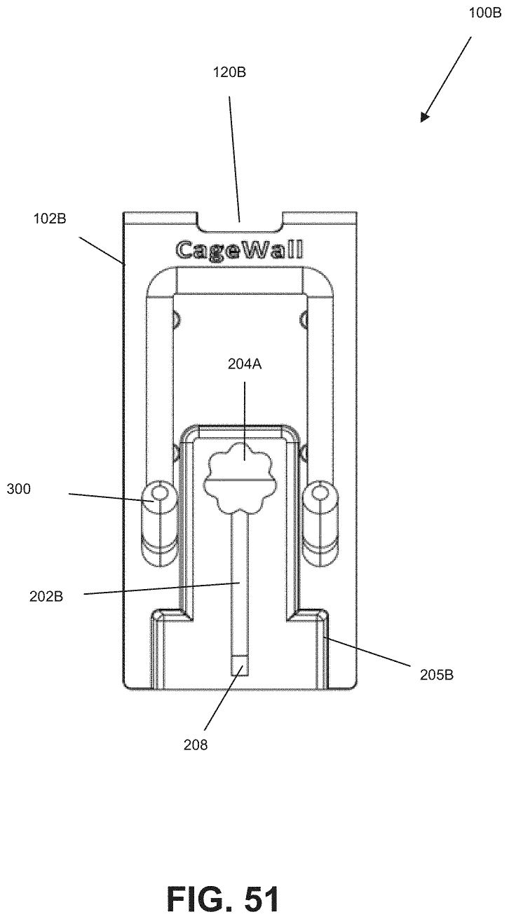

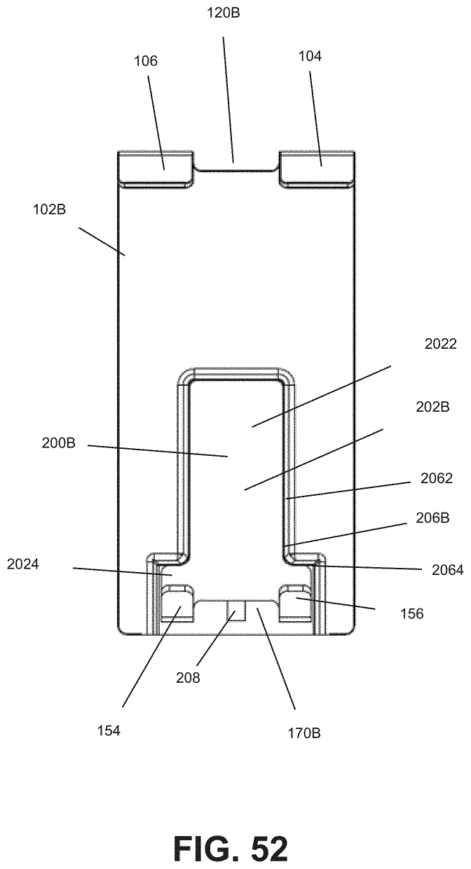

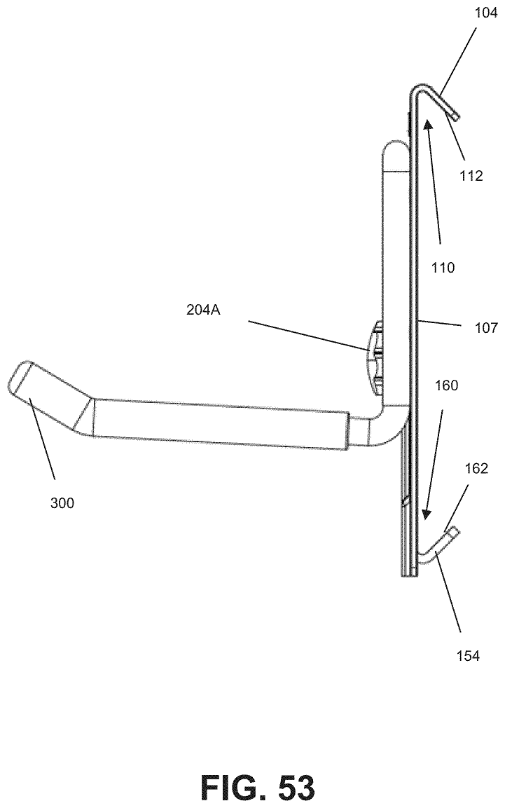

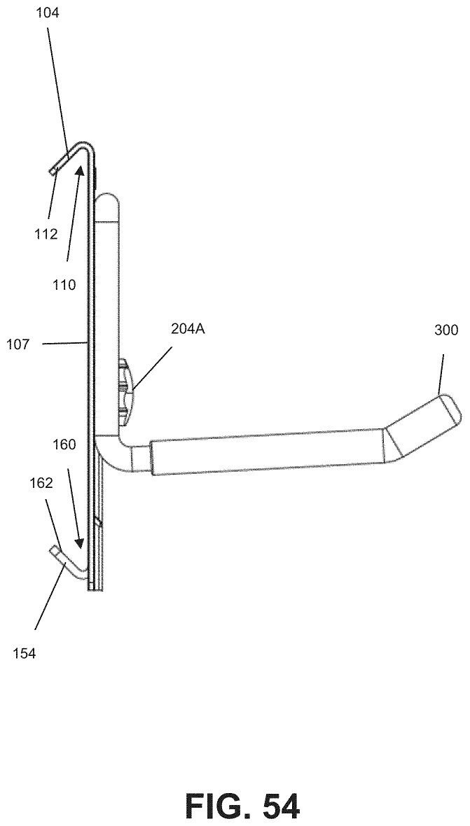

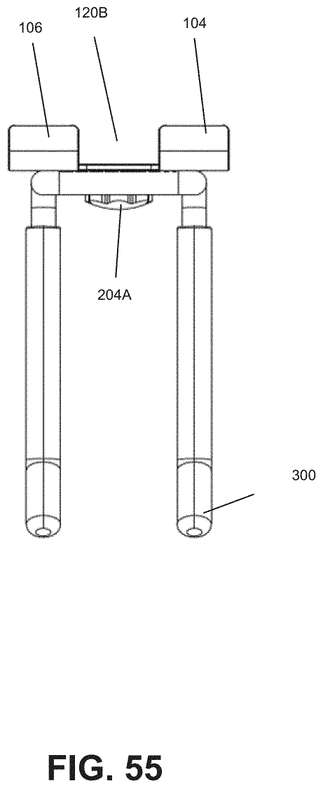

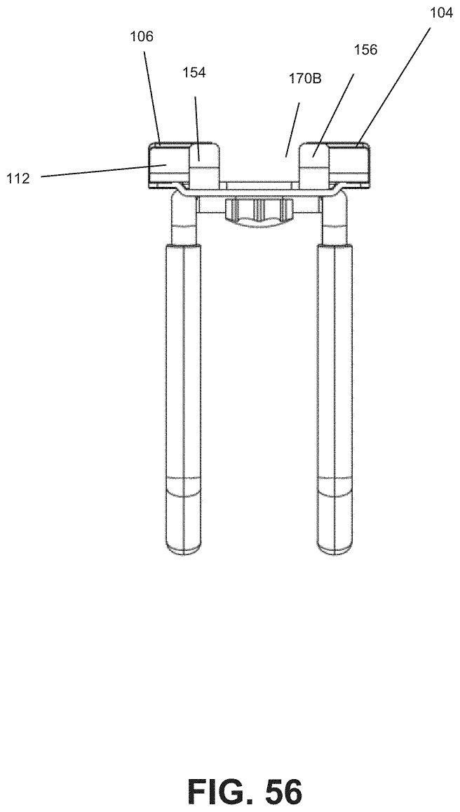

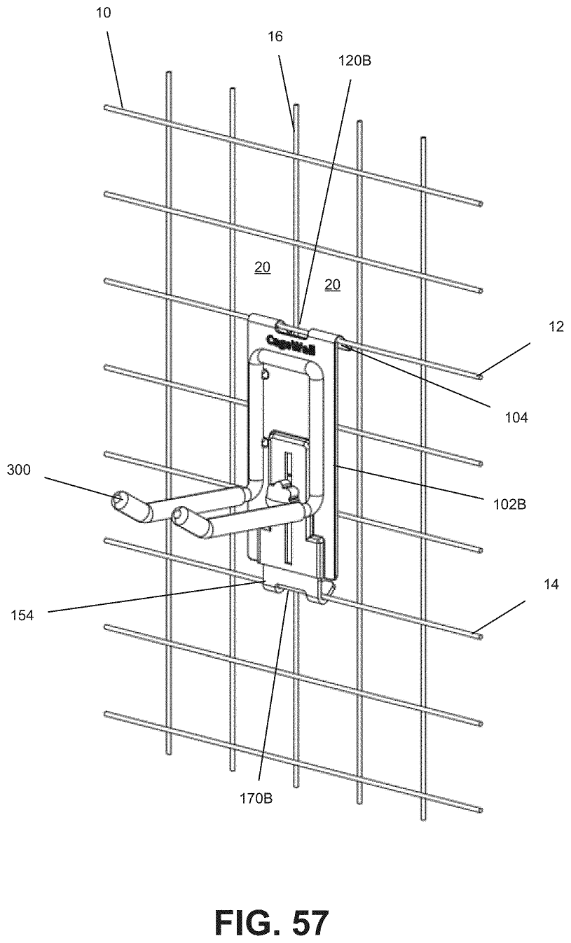

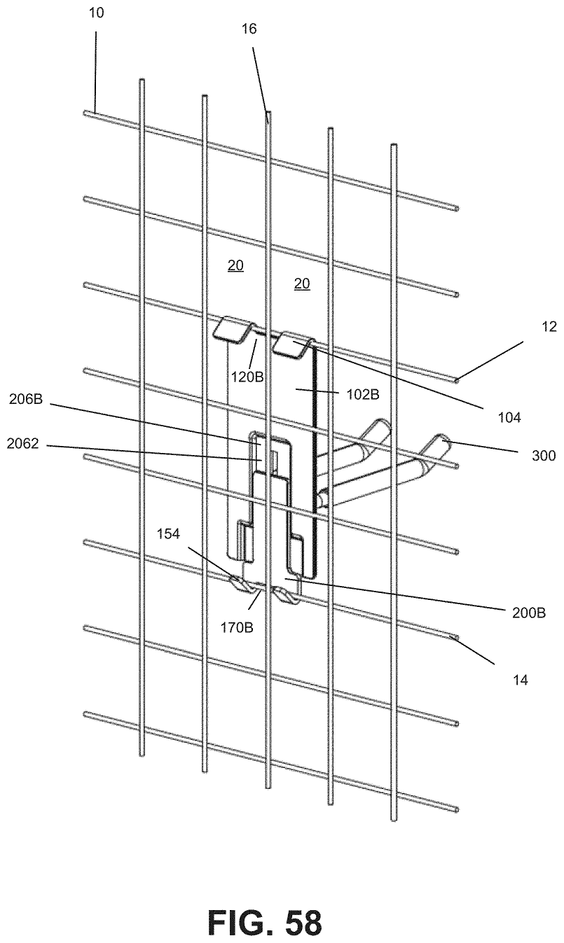

FIG. 49 to FIG. 58 depict a mounting assembly 100B that is an alternate embodiment of the mounting assembly 100A. The assembly 100B substantially corresponds to the assembly 100A, except: (i) the upper wire receiving space 120B of the bracket 102B of the assembly 100B is wider than the upper wire receiving space 120 of the assembly 100A, and (ii) the lower wire receiving space 170B of the connection counterpart-defining configuration 200B of the bracket 102B of the assembly 100B is wider than the lower wire receiving space 170 of the assembly 100A.

In some embodiments, for example, the width of the upper wire-receiving space 120B has a value of 1.5 inches.

In some embodiments, for example, the width of the lower wire-receiving space 170B has a value of 1.5 inches.

By increasing the width of the upper wire-receiving space 120B, a user can more easily hang the assembly 100B onto the wire lattice 10. By increasing the width of the upper wire receiving space 120B, a user can more easily dispose one or more wires of the wire lattice 10, for example, the intersecting wire 16, or both the intersecting wire 16 and the upper wire 12, to effect the hanging of the assembly 100B from the wire lattice 10 with reduced difficulty. In some embodiments, for example, the reduced difficulty in hanging the assembly 100B from the wire lattice 10 is particularly apparent while hanging an assembly 100B having more than one bracket 102B from the wire lattice 10. In such embodiments, for example, it is easier for a user to align the respective upper wire-receiving space 120B of each one of the plurality of brackets 102B with a respective one or more wires of the wire lattice 10 to effect the hanging of the assembly 100B from the wire lattice 10.

By increasing the width of the lower wire-receiving space 170B, a user can more easily grip and secure the assembly 100B to the wire lattice 10, while the assembly 100B is hanging from the wire lattice 10. By increasing the width of the lower wire receiving space 170B, a user can more easily dispose one or more wires of the wire lattice 10, for example, the intersecting wire 16, or both the intersecting wire 18 and the lower wire 14, to effect the gripping and securing of the assembly 100B to the wire lattice 10 with reduced difficulty. In some embodiments, for example, the reduced difficulty in gripping and securing the assembly to the wire lattice 10 is particularly apparent while gripping and securing an assembly 100B having more than one bracket 102B, or having one bracket 102B with more than one connection counterpart-defining configuration 200B, to the wire lattice 10. In such embodiments, for example, it is easier for a user to align the respective lower wire-receiving space 170B with a respective one or more wires of the wire lattice 10 to effect the gripping and securing of the assembly 100B to the wire lattice 10.

In some embodiments, for example, due to the increase in width of the lower wire-receiving space 1708, at least a portion of the width of the connection counterpart-defining configuration 200Bis also increased. As depicted in FIG. 49 to 52, the intermediate member 202B includes an upper intermediate member portion 2022 and a lower intermediate member portion 2024, wherein the lower intermediate member portion 2024 is disposed below the upper intermediate member portion 2022. As depicted, the width of the lower intermediate member portion 2024 is greater than the width of the upper adjustable member portion 2022. As depicted, the width of the lower intermediate member portion 2024 is greater than the width of the connection counterpart-defining configuration 200 of the assembly 100 or the assembly 100A. As depicted, the lower bracket-defined connection counterpart 154 is connected to the lower adjustable member portion 2024.

In some embodiments, for example, due to the increase in width of the lower intermediate member portion 2024, at least a portion of the width of the recess 206B, defined by the raised portion 205B of the flange 103B of the bracket member 1021B, is also increased for receiving the lower intermediate member portion 2024 while the bracket 102B is disposed in the retracted configuration. As depicted in FIG. 49 to 52, the recess 206B includes an upper recess portion 2062 and a lower recess portion 2064, wherein the lower recess portion 2064 is disposed below the upper recess portion 2062. As depicted, the width of the lower recess portion 2064 is greater than the width of the upper recess portion 2062. As depicted, the width of the lower recess portion 2064 is greater than the width of the recess 206 of the assembly 100 or the assembly 100A. In some embodiments, for example, the width of the lower recess portion 2064 corresponds to the width of the lower adjustable member portion 2024 such that, while the bracket 102B is disposed in the retracted configuration, the lower adjustable member portion 2024 is received in the lower recess portion 2064.

The mounting assembly 100B can be connected to, and secured to, a wire lattice 10, similar to the manner by which the connection and securing between the mounting assembly 100 to the wire lattice 10, is established.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations could be made herein.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1-22. (canceled)

23. A bracket configured to be connected to a wire lattice, the wire lattice defined by a plurality of wires, the plurality of wires including an upper wire and a lower wire, wherein the lower wire is disposed below the upper wire, the bracket comprising:
an upper bracket-defined connection counterpart defining a hook, wherein:
the hook is configured for hooking onto the upper wire such that the hook and the upper wire are co-operatively disposed in a hooked configuration, and with effect that the bracket is hanging from the wire lattice; and
a lower bracket-defined connection counterpart, disposed below the upper bracket-defined connection counterpart, and defining a lower rotation-opposing configuration for disposition relative to the lower wire;
wherein:
the spacing between the upper bracket-defined connection counterpart and the lower bracket-defined connection counterpart is adjustable between at least a rotation resistant spacing and a rotation permissive spacing;
while: (i) the hook and the upper wire are disposed in the hooked configuration, and (ii) the spacing between the upper bracket-defined connection counterpart and the lower bracket-defined connection counterpart is the rotation-resistant spacing, the lower rotation-opposing configuration is disposed relative to the lower wire, such that the lower rotation-opposing configuration opposes rotation of the bracket, relative to the wire lattice, in a first direction, and also opposes rotation of the bracket, relative to the wire lattice in a second direction, wherein the first direction is opposite to the second direction; and
while: (i) the hook and the upper wire are disposed in the hooked configuration, and (ii) the spacing between the upper bracket-defined connection counterpart and the lower bracket-defined connection counterpart is the rotation-permissive spacing, the lower rotation-opposing configuration is disposed relative to the lower wire, such that: (i) there is an absence of opposing of rotation of the bracket, relative to the wire lattice, by the lower rotation-opposing configuration, in the first direction, and (ii) there is an absence of opposing of rotation of the bracket, relative to the wire lattice by the lower rotation-opposing configuration, in the second direction.

24. The bracket of claim 23, wherein the bracket is configurable in a fixed configuration and an adjustable configuration, wherein:
in the fixed configuration, there is an absence of adjustability of the spacing between the upper and lower bracket-defined connection counterparts;
in the adjustable configuration, the spacing between the upper and lower bracket connection counterparts is adjustable between at least the rotation resistant spacing and the rotation permissive spacing.

25. The bracket of claim 24, wherein, while the bracket is configured in the adjustable configuration, the spacing between the upper and lower bracket connection counterparts is adjustable between at least a first spacing and a second spacing, wherein:
in the first spacing, the upper and lower bracket connection counterparts are disposed for connection to a first pair of wires of the plurality of wires of the wire lattice spaced apart by a first spacing distance;
in the second spacing, the upper and lower bracket connection counterparts are disposed for connection to a second pair of wires of the plurality of wires of the wire lattice spaced apart by a second spacing distance.

26. The bracket of claim 25, wherein the first spacing distance is different from the second spacing distance.

27. The bracket of claim 23, wherein the upper bracket-defined connection counterpart further comprises an upper wire-receiving space configured to receive at least a portion of the upper wire, such that the co-operative disposition of the hook and the upper wire in the hooked configuration is effectible.

28. The bracket of claim 27, wherein the plurality of wires of the wire lattice includes an intersecting wire, the intersecting wire intersecting at least the upper wire, the upper wire-receiving space further configured to receive at least a portion of the intersecting wire, such that the co-operative disposition of the hook and the upper wire in the hooked configuration is effectible.

29. The bracket of claim 27, wherein the width of the upper wire-receiving space has a minimum value of at least 0.3 inches.

30. The bracket of claim 27, wherein the width of the upper wire-receiving space has a value of 1.5 inches.

31. The bracket of claim 23, wherein the lower bracket-defined connection counterpart further comprises a lower wire-receiving space configured to receive at least a portion of the lower wire, such that the disposition of the lower rotation-opposing configuration, relative to the lower wire, such that the lower rotation-opposing configuration opposes rotation of the bracket, relative to the wire lattice, in the first direction and also in the second direction, is effectible.

32. The bracket of claim 31, wherein the plurality of wires of the wire lattice includes an intersecting wire, the intersecting wire intersecting at least the lower wire, the lower wire-receiving space further configured to receive at least a portion of the intersecting wire, such that the disposition of the lower rotation-opposing configuration, relative to the lower wire, such that the lower rotation-opposing configuration opposes rotation of the bracket, relative to the wire lattice, in the first direction and also in the second direction, is effectible.

33. The bracket of claim 31, wherein the width of the lower wire-receiving space has a minimum value of at least 0.3 inches.

34. The bracket of claim 31, wherein the width of the lower wire-receiving space has a value of 1.5 inches.

35. The bracket of claim 23, wherein the upper bracket-defined connection counterpart defines an internal curved surface that is configured for disposition in contact engagement with the upper wire while the hook and the upper wire are co-operatively disposed in the hooked configuration.

36. The bracket of claim 35, wherein the radius of curvature of the internal curved surface of the upper bracket-defined connection counterpart has a minimum value of 1/64 inches.

37. The bracket of claim 35, wherein the radius of curvature of the internal curved surface of the upper bracket-defined connection counterpart has a value of ⅛ inches.

38. The bracket of claim 23, wherein the lower bracket-defined connection counterpart defines an internal curved surface that is configured for disposition in contact engagement with the lower wire while: (i) the hook and the upper wire are co-operatively disposed in the hooked configuration, and (ii) the spacing between the upper bracket-defined connection counterpart and the lower bracket-defined connection counterpart is the rotation-resistant spacing.

39. The bracket of claim 38, wherein the radius of curvature of the internal curved surface of the lower bracket-defined connection counterpart has a minimum value of 1/64 inches.

40. The bracket of claim 38, wherein the radius of curvature of the internal curved surface of the lower bracket-defined connection counterpart has a value of ⅛ inches.

41. A bracket configured to be connected to a wire lattice, the wire lattice defined by a plurality of wires, the plurality of wires including an upper wire and a lower wire, wherein the lower wire is disposed below the upper wire, the kit comprising:
a bracket member, defining an upper bracket-defined connection counterpart defining a hook, wherein:
the hook is configured for hooking onto the upper wire such that the hook and the upper wire are co-operatively disposed in a hooked configuration, and with effect that the bracket is hanging from the wire lattice; and
a connection counterpart-defining configuration, releasably coupled to the bracket member, and defining a lower bracket-defined connection counterpart, disposed below the upper bracket-defined connection counterpart, the lower bracket-defined connection counterpart defining a lower rotation-opposing configuration for disposition relative to the lower wire;
wherein:
the spacing between the upper bracket-defined connection counterpart and the lower bracket-defined connection counterpart is adjustable between at least a rotation resistant spacing and a rotation permissive spacing;
while: (i) the hook and the upper wire are disposed in the hooked configuration, and (ii) the spacing between the upper bracket-defined connection counterpart and the lower bracket-defined connection counterpart is the rotation-resistant spacing, the lower rotation-opposing configuration is disposed relative to the lower wire, such that the lower rotation-opposing configuration opposes rotation of the bracket, relative to the wire lattice, in a first direction, and also opposes rotation of the bracket, relative to the wire lattice in a second direction, wherein the first direction is opposite to the second direction; and
while: (i) the hook and the upper wire are disposed in the hooked configuration, and (ii) the spacing between the upper bracket-defined connection counterpart and the lower bracket-defined connection counterpart is the rotation-permissive spacing, the lower rotation-opposing configuration is disposed relative to the lower wire, such that: (i) there is an absence of opposing of rotation of the bracket, relative to the wire lattice, by the lower rotation-opposing configuration, in the first direction, and (ii) there is an absence of opposing of rotation of the bracket, relative to the wire lattice by the lower rotation-opposing configuration, in the second direction.

42. A kit for a bracket configured to be connected to a wire lattice, the wire lattice defined by a plurality of wires, the plurality of wires including an upper wire and a lower wire, wherein the lower wire is disposed below the upper wire, the kit comprising:
a bracket member, defining an upper bracket-defined connection counterpart defining a hook, wherein:
the hook is configured for hooking onto the upper wire such that the hook and the upper wire are co-operatively disposed in a hooked configuration, and with effect that the bracket is hanging from the wire lattice; and
a connection counterpart-defining configuration, releasably couplable to the bracket member, and defining a lower bracket-defined connection counterpart, the lower bracket-defined connection counterpart defining a lower rotation-opposing configuration for disposition relative to the lower wire;
wherein, while the bracket member and the connection counterpart-defining configuration are releasably coupled, the lower bracket-defined connection counterpart is disposed below the upper bracket-defined connection counterpart, and the bracket is defined, and:
the spacing between the upper bracket-defined connection counterpart and the lower bracket-defined connection counterpart is adjustable between at least a rotation resistant spacing and a rotation permissive spacing;
while: (i) the hook and the upper wire are disposed in the hooked configuration, and (ii) the spacing between the upper bracket-defined connection counterpart and the lower bracket-defined connection counterpart is the rotation-resistant spacing, the lower rotation-opposing configuration is disposed relative to the lower wire, such that the lower rotation-opposing configuration opposes rotation of the bracket, relative to the wire lattice, in a first direction, and also opposes rotation of the bracket, relative to the wire lattice in a second direction, wherein the first direction is opposite to the second direction; and
while: (i) the hook and the upper wire are disposed in the hooked configuration, and (ii) the spacing between the upper bracket-defined connection counterpart and the lower bracket-defined connection counterpart is the rotation-permissive spacing, the lower rotation-opposing configuration is disposed relative to the lower wire, such that: (i) there is an absence of opposing of rotation of the bracket, relative to the wire lattice, by the lower rotation-opposing configuration, in the first direction, and (ii) there is an absence of opposing of rotation of the bracket, relative to the wire lattice by the lower rotation-opposing configuration, in the second direction.
